(19) United States
(12) Patent Application Publication
(10) Pub. No.: US 2025/0137592 A1
(43) Pub. Date: May 1, 2025

(54) INLINE COOLING SYSTEM FOR HYDROGEN REFUELING STATIONS

(71) Applicant: DHES B.V., Nuenen (NL)

(72) Inventor: Wilhelmus Franciskus Schoonen, Nuenen (NL)

(73) Assignee: DHES B.V., Nuenen (NL)

(21) Appl. No.: 18/690,280

(22) PCT Filed: Sep. 8, 2022
(86) PCT No.: PCT/EP2022/074967

§ 371 Date: Mar. 8, 2024

(30) Foreign Application Priority Data
Sep. 9, 2021 (EP) 21195749.3
Oct. 7, 2021 (EP) 21201456.7

(51) Int. Cl. F17C 7/00

(52) U.S. Cl. CPC F17C 7/00; F17C 2205/0323; F17C 2205/0338; F17C 2205/037; F17C 2221/012; F17C 2227/0355; F17C 2250/0443; F17C 2265/065; F17C 2270/0168; F17C 2270/0184

(57) ABSTRACT

An inline cooling system for controlled delivery of a gaseous substance, comprising a conduit (140) for transporting the gaseous substance from a gas supply unit (190) to an outlet (152), wherein the gas supply unit (190) is configured to supply the gaseous substance in a pressurized form. A primary variable flow regulator (103) is arranged along the conduit (140) to regulate a flow through the conduit. A secondary variable flow regulator (103) is arranged along the conduit (140) to regulate the flow through the conduit. At least one heat exchanger (106) is arranged along the conduit (140) in between the primary variable flow regulator (103) and the secondary variable flow regulator (151), wherein the heat exchanger (106) is configured to extract heat from the gaseous substance inside the conduit.

### FIELD OF THE INVENTION

The invention relates to an inline system for controlled delivery of a gaseous substance.

### BACKGROUND OF THE INVENTION

Electric power can be generated by a fuel cell, using hydrogen as a fuel. To this end, the fuel cell needs to be provided with hydrogen. Electric vehicles and other fuel cell-powered devices may comprise a hydrogen tank to store the hydrogen before use. Refueling of the hydrogen tank remains a challenging operation. The challenges may be found in the challenging pressure and temperature conditions under which the hydrogen is stored and supplied. Another challenge lies in reducing the energy consumption of the refueling process itself: the compressing, storing, and cooling of hydrogen before it is finally delivered to the fuel cell-powered device.

Because of safety concerns, it is necessary to regulate the gas delivery. For example, the temperature and pressure of the gas that is delivered to the vehicle, as well as the speed (e.g. mass flow) at which the gas is delivered, need to be controlled. For example, regulations may prescribe a Hydrogen temperature in the range from −40 to −33 degrees. The flow of hydrogen into the vehicle may also be restricted, for safety reasons. To deal with these conditions, an efficient cooling system is desired. Also an efficient design of a gas refueling station, in particular a hydrogen station, is desirable.

### SUMMARY OF THE INVENTION

According to an aspect of the invention, an inline cooling system for controlled delivery of a gaseous substance, in particular hydrogen, is provided, comprising
a conduit for transporting the gaseous substance from a gas supply unit to an outlet, wherein the gas supply unit is configured to supply the gaseous substance in a pressurized form;
a primary variable flow regulator arranged along the conduit to regulate a flow through the conduit;
a secondary variable flow regulator arranged along the conduit to regulate the flow through the conduit; and
at least one heat exchanger arranged along the conduit in between the primary variable flow regulator and the secondary variable flow regulator, wherein the heat exchanger is configured to extract heat from the gaseous substance inside the conduit.

According to another aspect of the invention, a method of inline cooling for controlled delivery of a gaseous substance, in particular hydrogen, is provided, the method comprising
transporting the gaseous substance, in a pressurized form, from a gas supply unit, through a conduit to an outlet;
regulating a flow through the conduit by a primary variable flow regulator arranged along the conduit;
extracting heat from the gaseous substance inside the conduit by at least one heat exchanger arranged along the conduit in between the primary variable flow regulator and a secondary variable flow regulator; and
regulating the flow through the conduit further by the secondary variable flow regulator arranged along the conduit.

The person skilled in the art will understand that the features described above may be combined in any way deemed useful. Moreover, modifications and variations described in respect of the system may likewise be applied to the method and to the computer program product, and modifications and variations described in respect of the method may likewise be applied to the system and to the computer program product.

### BRIEF DESCRIPTION OF THE DRAWINGS

In the following, aspects of the invention will be elucidated by means of examples, with reference to the drawings. The drawings are diagrammatic and may not be drawn to scale. Throughout the drawings, similar items may be marked with the same reference numerals.

FIG. 1 shows a diagram of a hydrogen fueling station including an inline cooling system.

FIG. 2 shows a diagram of a hydrogen fueling station including a two-phase inline cooling system.

FIG. 3 shows a diagram of a hydrogen fueling station including an inline cooling system with an intermediate cooling unit.

FIG. 4A shows a partly worked open view of a heat exchanger for refrigerating a fluid.

FIG. 4B shows a cross section in longitudinal direction of the heat exchanger for refrigerating a fluid of FIG. 4A.

FIG. 5 shows a cross section of a pipe with a tracing shield.

FIG. 6 shows a flowchart of a method of inline cooling for controlled delivery of a gaseous substance, such as hydrogen.

### DETAILED DESCRIPTION OF EMBODIMENTS

In the following detailed description, certain exemplary embodiments will be described in greater detail, with reference to the accompanying drawings. The matters disclosed in the description, such as detailed construction and elements, are provided to assist in a comprehensive understanding of the exemplary embodiments. Accordingly, it is apparent that the exemplary embodiments can be carried out without those specifically defined matters. Also, well-known operations or structures are not described in detail, since they would obscure the description with unnecessary detail.

In the following description, the fueling station will be described in the context of fuel-cell based electric vehicles (FCEV). However, the present disclosure is not limited to vehicles. The vehicle mentioned throughout the present disclosure may be replaced by any fuel-cell based electric device. Moreover, although the present disclosure may be advantageously applied to other gaseous substances, it will be understood that the present disclosure is particularly suited for hydrogen stations. Throughout this disclosure, a gaseous substance may be a gas, in particular hydrogen, or a gas mixture.

A gaseous substance in pressurized form may be understood as gaseous substance having a pressure well above the pressure of ambient air, e.g. above 1 bar. Generally the gaseous substance in pressurized form may be high-pressure gaseous substance with a pressure above 50 bar, preferably above 100 bar, in certain cases preferably above 500 bar, more preferably above 1000 bar.

Refueling fuel-cell based electric vehicles (FCEV) is typically performed with cooled fuel, in particular hydrogen. For example, the temperature of the fuel supplied by a refueling station to a vehicle may be between −40 degrees Celsius to −33 degrees Celsius. In the refueling station, the fuel may be stored at ambient temperature, for example between −10 degrees Celsius to +40 degrees Celsius. Also, during compression and expansion, the temperature of the fuel may greatly increase. Thus, a substantial amount of cooling is needed to prepare the fuel for fueling. The fueling capacity may vary, and can normally be between 15 and 60 grams per second, for example.

Most refueling systems work with tube-in-tube systems and/or micro-channel heat exchangers. These heat exchangers are not very efficient and rely on a high temperature difference between the fuel (hydrogen) and the cooling medium, i.e. a refrigerant or coolant. That is, the refrigerant or coolant needs to be cooled down to a much lower temperature than the desired temperature of the fuel after cooling. That results in a high energy consumption. The microchannel heat exchangers may also be used as an accumulation of cold. In that case a back-to-back refueling is not possible. The hydrogen flowing through the pipes may even increase in temperature due to the Joule-Thomson effect. In particular when different sections of the tube have different cross sectional dimensions, or when the tube has curvature, the tube will cause an increase of the temperature of the hydrogen flowing through the tube. This increase of temperature needs to be compensated by the active cooling system in order to realize the desired range of e.g. −40 to −33 degrees Celsius at the nozzle where the dispenser of the fueling station connects to the vehicle.

Certain aspects of the present disclosure may be helpful to improve efficiency of the cooling system of a fueling station. Moreover, certain aspects of the present disclosure may enable a more convenient setup of the fueling station.

According to an example, an inline cooling system for controlled delivery of a gaseous substance is provided, comprising a conduit for transporting the gaseous substance from a pressurized supply to an outlet, at least one heat exchanger arranged along the conduit in between a primary variable flow regulator and a secondary variable flow regulator, wherein the heat exchanger is configured to extract heat from the gaseous substance inside the conduit.

The primary variable flow regulator may be arranged along the conduit in between the pressurized supply and the at least one heat exchanger to control a flow of the gaseous substance through the conduit from the pressurized supply towards the at least one heat exchanger. The secondary variable flow regulator may be arranged along the conduit in between the at least one heat exchanger and the outlet to control a flow of the gaseous substance through the conduit from the at least one heat exchanger towards the outlet. For example, in certain embodiments, there is no further heat exchanger or compressor along the trajectory between the secondary variable flow regulator and the outlet. The outlet may comprise a nozzle to connect the conduit to a vehicle or another fuel-cell based electric device.

For example, an inline cooling system for controlled delivery of a gaseous substance, in particular hydrogen, comprises a conduit for transporting the gaseous substance from a gas supply unit to an outlet, wherein the gas supply unit is configured to supply the gaseous substance in a pressurized form, a primary variable flow regulator arranged along the conduit to regulate a flow through the conduit, a secondary variable flow regulator arranged along the conduit to regulate the flow through the conduit, and at least one heat exchanger arranged along the conduit in between the primary variable flow regulator and the secondary variable flow regulator, wherein the heat exchanger is configured to extract heat from the gaseous substance inside the conduit.

By virtue of the primary and secondary variable flow regulators, the conditions of the flowing gaseous substance can be controlled better. The flow rate through the heat exchanger can be better controlled, so that the cooling effect of the heat exchanger may be improved. Further, the flow towards the outlet is better controllable. This may be particularly advantageous if the trajectory of the conduit from the heat exchanger to the outlet is relatively long. Since there are two variable flow regulators, the pressure drop at the secondary variable flow regulator can be relatively small, thus keeping a Joule-Thomson effect at the secondary variable flow regulator at a minimum. The outlet can be placed further away from the heat exchanger, while still being able to accurately control the outflow of the gaseous substance using the secondary variable flow regulator.

When in use, the flow may be controlled mainly by the primary variable flow regulator, so that the secondary variable flow regulator does not need to reduce the flow that much further. Therefore, the Joule-Thomson effect at the secondary variable flow regulator may also be relatively small, i.e. much smaller than at the primary variable flow regulator. This way, the flow can be fine-tuned at the secondary variable flow regulator without needing to cool down the gaseous substance after the secondary variable flow regulator.

The primary variable flow regulator may be configured to, in a fueling mode of operation, restrict the flow of the fuel more than the secondary variable flow regulator does. This way the main flow control is performed by means of the primary variable flow regulator, while the secondary variable flow regulator can be used for fine-tuning the flow.

The secondary variable flow regulator may be configured to, in an initialization mode, gradually open until a pressure inside the conduit has equalized with a pressure inside a vessel connected to the outlet. This helps to improve safety when connecting a vehicle to the dispenser, because the pressure inside the fuel tank of the vehicle differ from the pressure in the conduit. For example, the secondary variable flow regulator may start in a closed position and gradually open until the pressure has equalized. For example, the secondary variable flow regulator may open up to at most 10% of its maximal throughput capacity while equalizing. After the initialization mode has finalized, the fueling mode may be entered, in which the secondary variable flow regulator may be opened further.

The conduit may have a first diameter throughout the heat exchanger and a second diameter outside the heat exchanger, wherein the first diameter is equal to the second diameter. This allows the gaseous substance to pass with relatively little resistance. Preferably the diameter of the conduit is constant at both the inlet and outlet of the heat exchanger.

The conduit may have a fixed diameter throughout from the primary flow regulator through the heat exchanger to the secondary flow regulator. This may help to improve energy efficiency of the cooling system. It reduces undesired Joule-Thomson effect along the conduit.

The conduit may have the same fixed diameter from the secondary flow regulator to an outlet and/or from the pressurized gas supply to the primary flow regulator. This may help to further improve energy efficiency of the cooling system.

The conduit may have the same fixed diameter in between any pair of fluid components arranged subsequently along the conduit from the pressurized supply to an outlet. Herein, the pair of subsequent fluid components may comprise two fluid components, wherein each fluid component comprises a valve, a flow regulator, or a measurement device. In certain embodiments, each fluid component only comprises a valve or a flow regulator but no measurement device, wherein any measurement device does not involve a narrowing of the conduit. These provisions may reduce the inadvertent heating of the gaseous substance.

A length of a portion of the conduit in between the heat exchanger and the secondary flow regulator may be greater than 10 meters. It may be advantageous to have the cooling unit at a distance from the outlet, and the techniques disclosed herein may be used to advantage when this is the case.

The system may comprise a binary valve to selectively close the conduit in between the secondary variable flow regulator and the outlet. This may improve safety when no vehicle is connected to the outlet.

The system may further comprise a cooling apparatus comprising a first housing enclosing the heat exchanger and the primary flow regulator; and a dispenser for dispensing the gaseous substance, wherein the dispenser comprises a second housing separate from the first housing, the second housing enclosing the secondary flow regulator, wherein the conduit extends through the cooling apparatus and through the dispenser, and wherein the cooling apparatus and the dispenser are distinct devices or disjunct devices, i.e. one device is not enclosed by the other. The variable flow regulators allow to separate the cooling from the actual dispenser. For example, the cooling apparatus and the dispenser may be constructional works, e.g. firmly connected to a ground, wherein a distance between the heat exchanger and the dispenser may be greater than 10 meters.

The system may further comprise an active cooling element that extends along the part of the conduit in between the cooling apparatus and the dispenser. This may allow a greater distance between the cooling system and the dispenser. It may avoid the need for a cooling unit to cool down the gaseous substance at the distributor.

The system may further comprise a control unit configured to control the primary variable flow regulator and the secondary variable flow regulator, based on a demand for the gaseous substance at the fueling dispenser. The control unit may improve safety and improve efficiency by efficiently controlling the system.

The control unit may be configured to control the primary variable flow regulator to restrict the flow by a first amount and control the secondary variable flow regulator to restrict the flow by a second amount, based on a demand for the gaseous substance at the fueling dispenser, wherein the second restriction amount can be a fraction of the first restriction amount, wherein the fraction is preferably less than or equal to 10%, more preferably less than or equal to 1%. The low restriction amount imposed by the secondary variable flow regulator may avoid the gaseous substance to heat up. The restriction amount of a variable flow regulator may be expressed, for example, as a difference of the pressure before and after the flow regulator, or as a ratio of the pressure before and after the flow regulator, or as an amount (e.g. a percentage) to which the flow regulator is closed, for example.

For example, the control unit may be configured to control the primary variable flow regulator to locally reduce the area of cross section of the conduit, compared to the area of cross section of the conduit before the primary flow regulator, by a first fraction and control the secondary variable flow regulator to locally reduce the area of the cross section of the conduit, compared to the area of cross section of the conduit before the secondary flow regulator, by a second fraction, based on a demand for the gaseous substance at the fueling dispenser, wherein the second fraction is less than or equal to 10%, preferably less than or equal to 1%, of the first fraction.

The primary flow regulator and the secondary flow regulator may be configured to cause a pressure drop of the gaseous substance at the primary flow regulator to be greater than a pressure drop of the gaseous substance at the secondary flow regulator. The low restriction imposed by the secondary variable flow regulator may avoid the gaseous substance to heat up.

The secondary flow control valve may be configured to have a pressure reduction effect of at most 1%, i.e. reduce the pressure by at most 1%, substantially during the actual fueling.

The at least one heat exchanger may have a shape of a torus. This may provide a particularly efficient heat exchanger because the Joule-Thomson effect within the heat exchanger may be kept to a minimum.

The inline cooling system may further comprise an intermediate cooling unit configured to cool the gaseous substance received from the gas supply to obtain cooled gaseous substance and returning the cooled gaseous substance to the pressurized supply. This improves the safety related to the compression of the gaseous substance.

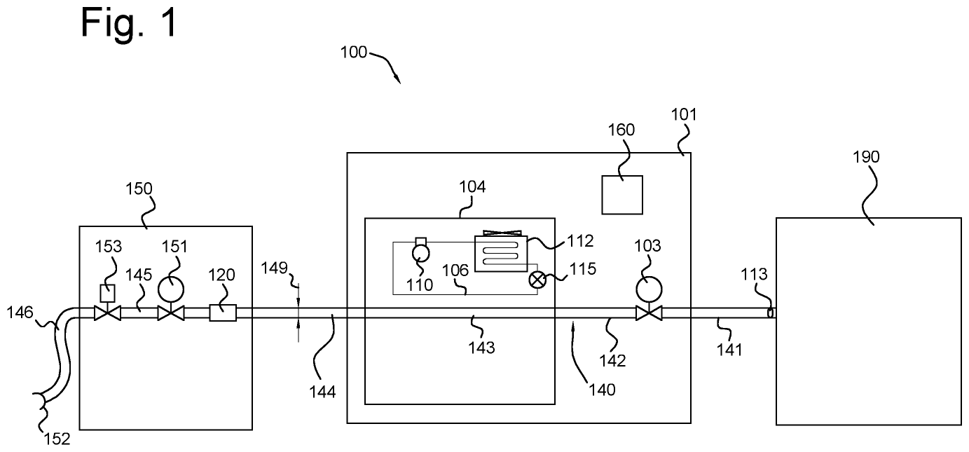

FIG. 1 shows a simplified diagram of a fueling station 100. Note that the figure is highly diagrammatical and is not drawn to scale. In this and other embodiments the fuel may be a gaseous substance, in particular hydrogen, although other gaseous substances are not excluded.

The fueling station 100 may comprise a pressurized gas supply unit 190 for providing the fuel under pressure. For example, the gas supply unit 190 may comprise one or more vessels, e.g. gas cylinders, in which the gaseous fuel is stored under high pressure. The gas supply unit 190 may further comprise a compressor and/or cooling system (not illustrated) to control the pressure and/or temperature of the fuel.

The fueling station 100 may further comprise a dispenser 150. The function of the dispenser is to actually deliver the fuel to a destination, such as an FCEV. For example, the dispenser 150 comprises an outlet 152, which can comprise a nozzle 152. The outlet 152 may be connectable to a corresponding inlet (e.g. a nozzle slot) of a device that has a gas tank to be filled by the fueling station.

The fueling station 100 may further comprise a conduit 140 from the storage system 190 to the dispenser 150. This conduit 140 may be, for example, a tube made of stainless steel or another suitable material. In certain embodiments, the conduit 140 has, as much as possible, the same cross section from the storage system 190 to the nozzle 152.

The fueling station 100 may further comprise a cooling unit 101. The cooling unit may be configured to cool the gaseous substance as it flows through the conduit 140 from the gas supply unit 190 towards the outlet 152. To that end, the cooling unit 101 may comprise a heat exchanger 106. The heat exchanger 106 may be configured to extract heat from the fuel inside the conduit 140 before it reaches the dispenser 150. For example, the heat exchanger 106 may be part of a refrigeration cycle 104 comprising the heat exchanger 106 as an evaporator of a refrigerant, a compressor 110 for compressing the refrigerant, a condenser 112 to condense the refrigerant, and an expansion valve 115 to expand the condensed refrigerant.

Further, the fueling station 100 may comprise a primary flow regulator 103 for regulating the flow of fuel through the conduit 140. The primary flow regulator 103 may be configured to regulate the mass flow of the fuel through the conduit. Moreover, the primary flow regulator 103 is variable, preferably continuously variable, so that the flow of the fuel through the conduit can be gradually adapted according to the circumstances. For example, the primary flow regulator 103 may be a variable area control device or a mass flow control valve.

The primary flow regulator 103 may be positioned along the portion of the conduit 141, 142 that connects the storage system 190 to the heat exchanger 106. The primary flow regulator 103 may cause a drop in the pressure of the fuel, which can as a side effect increase the heat of the fuel. Since the fuel runs through the flow regulator 103 before it reaches the heat exchanger 106, the heat exchanger 106 can remove the heat and cool the fuel to a temperature suitable for fueling. After that, any temperature increase of the fuel would be undesirable. To avoid unnecessary heating, the part of the conduit from the heat exchanger 144 to the nozzle 152 preferably imposes as little restrictions to the fuel as possible. Therefore the cross section of the conduit is kept constant. This way, heating of the fuel due to a Joule-Thomson effect may be reduced to a minimal amount.

Further, the fueling station 100 may comprise a secondary flow regulator 151 for regulating the flow of fuel through the conduit 140. The secondary flow regulator 151 may be configured to regulate the mass flow of the fuel through the conduit. Moreover, the secondary flow regulator 151 is variable, preferably continuously variable, so that the flow of the fuel through the conduit can be gradually adapted according to the circumstances. For example, the secondary flow regulator 151 may be a variable area control device or a mass flow control valve.

The dispenser 150 may comprise the secondary flow regulator 151. The secondary flow regulator 151 may be advantageous for safety and/or for improved control of the delivery of the fuel. Further, the flow regulator 151 may be configured for fine-tuning the flow of the fuel that is distributed to the outlet 152. Advantageously, the pressure drop (and any temperature increase caused thereby) caused by the secondary flow regulator is as small as possible. For example, the secondary flow regulator 151 may be variably controllable to slightly restrict the flow of fuel. This way, active refrigeration at the dispenser 150 may be avoided.

The secondary flow regulator 151 may be configured to completely closable to close the conduit 140 if no escape of gas through the outlet 152 is desirable, for example if the nozzle 152 is disconnected or the fueling is completed. Alternatively, in certain embodiments, the dispenser 150 may further comprise a binary valve 153 that has two positions: completely closed and completely open.

The dispenser 150 may comprise a mass flow meter 120 arranged to measure the mass flow through the conduit 140. The mass flow meter 120 may alternatively be arranged outside the dispenser 150. The measurement result generated by the mass flow meter 120 may be provided as an input to the control unit 160 that controls the primary flow regulator 103 and the secondary flow regulator 151.

The cross section of the conduit 140 for the fuel from the storage system 190 to the dispenser 150 and nozzle 152 is preferably constant in shape and size. Thus, the diameter 149 of the conduit may be constant throughout. Thus, the flow regulators 103 and 151 may be the only exceptions. It is noted that in certain embodiments, there may be more flow regulators, such as the valve 153, and/or differently positioned flow regulators. In certain embodiments, further components along the conduit 140 may have an effect of a restriction of the flow through the conduit as a side effect or as an intended effect. However, apart from these components, the conduit 140 may maintain its constant diameter 149. For example, the conduit 140 comprises a tube having a constant diameter throughout.

The cross section and diameter of the part 143 of the conduit inside the heat exchanger 106 may be the same as for the other parts 141, 142, 144, 145, 146 of the conduit. In certain embodiments the conduit from the distributer housing to the nozzle may comprise a flexible tube, which may have a slightly different cross section from the remainder 141, 142, 143, 144, 145 of the conduit. In certain embodiments the conduit 140 is made of a rigid material, such as a metal tube, from the storage system 190 to and through the dispenser 150.

In certain embodiments, the only deviations from the fixed diameter are at fluid components, i.e. components that regulate the flow or perform measurements on the gaseous substance inside the conduit. Examples of such flow components include, for example, a flow switch, the primary flow regulator 103, the secondary flow regulator 151, any further flow regulator, the binary valve 153, any further valve, the flow meter 120, and any further measurement device, such as a sensor.

It will be understood that throughout this disclosure, the flow components, in particular flow regulators and flow meters, may be implemented as single tube meters and double tube meters. Moreover, a flow component may comprise an inlet with the same diameter as the outlet, wherein the inner diameter of the inlet (e.g. DN10 or 10 mm) is identical to the inner diameter of the outlet and corresponds to the inner diameter of the conduit 140. Inside the flow component, in between the inlet and outlet of the flow component, there may be one or more sections of the conduit with a reduced inner diameter (e.g. DN6 or 6 mm) and/or a curved longitudinal axis. This may apply to all flow components, in particular flow regulators and/or flow meters.

The arrangement presented herein allows the dispenser 150 to have a simplified construction. Since the fuel may arrive at the dispenser 150 in fully cooled condition, and the flow regulator 151 only slightly increases the temperature of the fuel, further cooling may be omitted in the dispenser. Therefore, the dispenser is less complex and can be made more compact. This may be of importance, for example, because the dispenser 150 may be located in a position where there is a lot of traffic with vehicles to be fueled. Because of the smaller size of the dispenser, there can be more space for the vehicles.

Further, the overall efficiency of the fueling station may be improved. Factors that may be relevant for the efficiency include, firstly, the constant diameter 149 of the conduit 140 for the fuel, and secondly, the two flow regulators 103 and 151 that regulate the flow through the heat exchanger 106. Since the primary flow regulator 103 brings the fuel close to the desired pressure before the fuel is cooled in the heat exchanger 106, the temperature of the fuel does not increase much after it exits the heat exchanger 106. Indeed, the secondary flow regulator 151 does not cause as much temperature increase. Also, the secondary flow regulator 151 allows to provide detailed control of the flow near the outlet. This feature can be used to equalize the pressure inside the conduit with the pressure connected to the outlet 152. This feature can also be used to provide highly controlled outflow.

The heat exchanger 106 may be any type of heat exchanger, particularly a heat exchanger that can act as an evaporator for the refrigerant of the refrigeration cycle. An example is a plate heat exchanger, a tube-in-tube heat exchanger, or a microchannel heat exchanger.

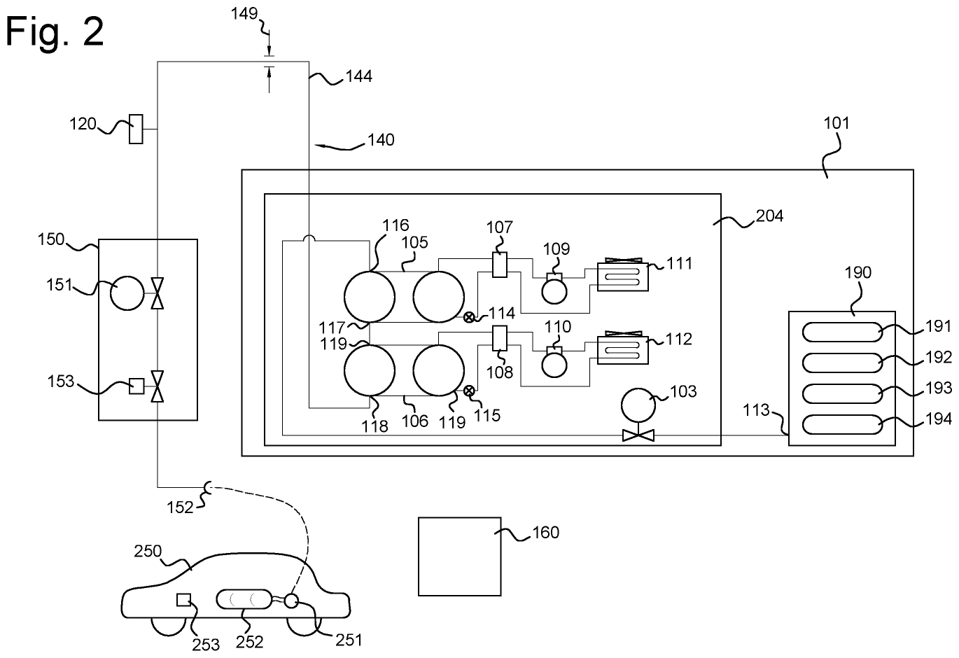

FIG. 2 shows an example fueling station in greater detail. Items similar to the items shown in FIG. 1 have been provided with the same reference numerals for reasons of conciseness. FIG. 2 shows a cooling subsystem 204 with two sequential stages. Each stage has a heat exchanger that extracts heat from the hydrogen in the conduit 140. The hydrogen first passes the first stage heat exchanger 105, followed by the second stage heat exchanger 106. The first stage heat exchanger 105 may reduce the temperature of the hydrogen to a first temperature, whereas the second stage heat exchanger 106 may reduce the temperature of the hydrogen to a second temperature, wherein the second temperature is lower than the first temperature. The second stage heat exchanger may be configured to cool the hydrogen down to a temperature suitable for delivering the hydrogen. For example, a temperature in between −40 degrees Celsius and −33 degrees Celsius. The first stage heat exchanger 105 may be configured to cool the hydrogen to a temperature as low as possible, so that the second stage heat exchanger, which operates at the lowest temperature, consumes as less energy as possible. The heat exchangers 105 and 106 shown in FIG. 2 are torus shaped heat exchangers. However, this is not a limitation. One or both of the heat exchangers 105 and 106 may be any suitable kind of heat exchanger, as described above. However a torus shaped heat exchanger may have certain advantages, as will be elaborated hereinafter.

The first heat exchanger 105 may be part of a first refrigeration cycle that may further comprise, a first compressor 109, a first condenser 111, and a first expansion valve 114. The first heat exchanger 105 may act as an evaporator for the refrigerant that circulates through the first refrigeration cycle. Likewise, the second refrigeration cycle may comprise the second heat exchanger 106, a second compressor 110, a second condenser 112, and a second expansion valve 115. The second heat exchanger 106 may act as an evaporator for the refrigerant that circulates through the second refrigeration cycle.

In certain embodiments, the conduit 140 has the same cross section, in particular a fixed diameter 140, across the system, from the outlet 113 of the gas supply 190 up to and including the dispenser. For example, this fixed diameter may be interrupted solely by flow regulators. Preferably, the fixed diameter is only interrupted by variable flow regulators. In certain embodiments, the diameter of the conduit is the same inside the heat exchanger(s) 105, 106 as in the remainder of the conduit 140.

The gas supply 190 may comprise several sources of the gas at different pressure values. For example, the gas supply 190 may comprise a plurality of gas storage facilities, for example gas tanks 191, 192,193, 194 in which the gaseous substance may be stored at different pressure levels. For example, cylinder 191 may comprise the gaseous substance at 150 bar, cylinder 192 may comprise the gaseous substance at 300 bar, cylinder 193 may comprise the gaseous substance at 600 bar, and cylinder 194 may comprise the gaseous substance at 1000 bar. However, these numeric values are merely non-limiting examples. During fueling, the gaseous substance may be supplied from one of the tanks depending on the desired delivery pressure. The desired delivery pressure may depend on the pressure in the tank 252 of the vehicle that is being filled.

The fueling station may comprise a control unit 160 configured to automatically operate the system. In particular the primary variable flow regulator 103, the secondary variable flow regulator 151, the valve 153, the first compressor 109, the fan of the first condenser 111, the first expansion valve 114, the second compressor 110, the fan of the second condenser 112, and/or the second expansion valve 115 may be controllable by the control unit. Further, the system may comprise several sensors, e.g. flow sensors, pressure sensors, temperature sensors, arranged at several places within the system. These sensors may transmit measurement results to the control unit 160. Other components may also be operatively coupled to the control unit 160. The control unit 160 may communicate wirelessly (as illustrated) or with a wired connection to each component. The control unit 160 may further be configured to communicate with the vehicle 250 that is being fueled.

For example, a mass flow meter 120 may be arranged to measure the mass flow through the conduit 140. For example, this mass flow meter 120 may be arranged along the conduit in between the cooling system 204 and the dispenser 150. However, the mass flow meter may alternatively be arranged elsewhere along the conduit, for example inside the dispenser 150, or inside the cooling system 204. Moreover, multiple flow meters may be provided along the conduit 140. Further, one or more thermometers may be arranged to measure the temperature of the gas inside the conduit. One or more pressure sensors may be arranged to measure the pressure of the gas inside the conduit. Moreover, one or more pressure sensors and/or temperature sensors may be provided to measure the pressure and/or temperature inside the evaporators 105, 106. It will be understood that, since the refrigeration cycle is a closed system, the temperature and pressure of the refrigerant are interrelated. Also, sensors may be provided in the gas supply 190, and send information about the current state of the gas in the cylinders 191, 192, 193, 194 to the control unit 160.

Further, the control unit 160 can receive information from the vehicle 250 or other unit to which the gas is delivered. The nozzle 152 may be connectable to an opening of the vehicle 250, and in conjunction herewith, electronic data communication may be performed between the control unit 160 of the cooling system and a control unit 253 of the vehicle 250. The data communication may be wired (by a wire parallel to the conduit 140), or may be wireless (as illustrated). Any suitable data communication protocol may be implemented for this communication procedure, such as Bluetooth or Wi-Fi or Ethernet.

For example, the control unit 160 may receive information from the vehicle 250 regarding the state of the gas tank 252 of the vehicle 250. This information may comprise, for example, a pressure inside the gas tank 252, a capacity of the gas tank 252, a percentage to which the gas tank 252 is filled, a temperature of the gas inside the gas tank 252, and/or a requested amount of gas to be delivered by the dispenser 150.

In certain embodiments, the control unit 160 may control the variable flow regulators, 103 and 151. The mass flow may be regulated by taking into account several parameters. For example, the fueling needs to be performed within prescribed limits. In certain embodiments, there is a predetermined maximum mass flow (e.g. 30 grams/second), a predetermined minimal temperature (e.g. −40 degrees Celsius), and/or a predetermined maximal temperature (e.g. −33 degrees Celsius) imposed to the gas that is delivered through the nozzle 152 to the vehicle 250. Also, depending on the current temperature, the flow of the gas through the conduit may be restricted to achieve sufficient cooling while the gas flows through the heat exchanger(s) 105, 106.

In certain embodiments, the control unit 160 requests the gas at a particular pressure from the gas supply 190 from the available pressures in the cylinders 191, 192, 193, 194. For example, the control unit receives the current pressure in the gas tank 252 of the vehicle 250 and selects the next-higher pressure among the available pressures in the gas supply 190. The gas supply 190 may comprise switching circuit to supply gas from the requested cylinder to the inlet 113 of the cooling unit 204.

By means of the control unit 160 the primary variable flow regulator 103 may be controlled to reduce the pressure of the gas received from the gas supply 190 at a certain pressure level down to slightly above the desired pressure level for fueling, based on e.g. the prescribed limits and/or the current measurements and fueling demand. For example, the flow regulator 103 is controlled to reduce the pressure by a certain amount, to achieve a desired flow rate of e.g. 30 grams/second.

The secondary variable flow regulator 151 may be configured to further reduce the pressure down to the desired pressure level for fueling. For example, the pressure drop created by the secondary variable flow regulator 151 may be set to a percentage of the pressure drop created by the primary variable flow regulator 103. This percentage may be, for example, 1%, 3%, 5%, or 10%. Alternatively, the secondary variable flow regulator 151 may be configured to reduce the mass flow with a given percentage of, for example, 1%, 3%, 5%, or 10%.

For example the temperature of the gas received from the gas supply 190, the pressure of the gas received from the gas supply 190, and a difference in the pressure in the tank 252 that is connected to the outlet 152 and the pressure of the gaseous substance received from the gas supply unit 190 may be taken into account to control the variable flow regulators 103 and 151.

For example, in case there are slight variations in the flow or pressure of the gas arriving at the dispenser 150, which may be measured e.g. by flow meter 120, the control unit 160 may control to adjust the setting of the secondary flow regulator 151 slightly, to achieve a constant flow at the outlet 152 of the dispenser 150.

It will be understood that there is a certain freedom in the design of the control algorithm that controls the primary variable flow regulator 103 and the secondary variable flow regulator 151, because the outflow at the outlet 152 is determined by their combined effect. However, to minimize any temperature increase in the dispenser 150, it is possible to impose, for example, a limit on the pressure drop generated by the secondary variable flow regulator 151 during fueling. For example, the pressure drop at the secondary variable flow regulator 151 may be set to at most 30 bar, preferably 25 bar, more preferably 20 bar. In that case, if more pressure reduction is desired than the maximum pressure drop at the secondary flow regulator, this will be regulated by controlling the primary variable flow regulator 103. In certain embodiments, also the primary variable flow regulator 103 is restricted by a maximum pressure drop, of for example 300 bar. This should be sufficient, if there are sufficient levels of available pressures in e.g. the cylinders 191, 192, 193, 194 of the gas supply 190.

Since the pressure drop created by the secondary variable flow regulator 151 is thus relatively small, there is only very little temperature increase of the gas inside the dispenser. This improves energy efficiency of the cooling system and may avoid the need for additional cooling in the dispenser 150. At the same time, the out-flow of the gas may be better controlled by the secondary variable flow regulator, which is positioned relatively close to the nozzle 152.

In certain embodiments, the pressure drop generated by the secondary variable flow regulator 151 varies, during the fueling process, in dependence on a total pressure difference between e.g. the gas tank 252 in the vehicle 250 and the gas received from the gas supply unit 190. For example the pressure drop may vary within an interval (e.g. +/−20%) around a default value (e.g. 20 bar).

In certain embodiments, the secondary variable flow regulator 151 is controlled differently during an initialization phase.

When the dispenser 150 is idle, to guarantee complete closure of the outlet 152, the conduit 140 may be closed by a (binary) flow valve 153. Alternatively, the secondary variable flow regulator 151 may be fully closed. Additionally, the flow from the gas supply unit 190 may be closed, e.g. by a binary valve of the gas supply unit 190 (not illustrated). Alternatively, the primary variable flow regulator 103 may be fully closed.

For example, there may be a pressure difference between the gas in the tank 252 of the vehicle 250 and the part 144 of the conduit 140 in between the cooling unit 204 and the dispenser 150. Therefore, the secondary variable flow regulator 151 may start in a closed position (or almost closed position). After opening the optional (binary) flow valve 153, the secondary variable flow regulator 151 may slowly open up to the desired level. This way, any pressure between the tank 252 and the conduit 140 may be equalized in a gentle manner.

Before fueling starts, data may be exchanged between the vehicle and the control unit 160 of the cooling system 204. For example, this data exchange may be triggered by the attachment of the nozzle 152 to the corresponding opening 251 of the vehicle 250. For example, the pressure inside the gas tank 252 of the vehicle 250 may be reported by the vehicle 250 to the control unit 160. Alternatively, this pressure may be measured by a pressure sensor (not shown) of the dispenser 150, located near the outlet of the dispenser. The control unit 160 also may receive a measurement of the pressure in the portion 144 of the conduit in between the dispenser 150) and the cooling unit 204. The speed in which the secondary variable flow regulator 151 opens, may be controlled in dependence on the pressure difference between these two pressures.

Optionally, after this equalization phase, the secondary variable flow regulator 151 is closed by the control unit 160, until the actual fueling begins.

For example, after the initial pressure equalization phase, the control unit 160 controls the gas supply 190 to supply gas at a selected pressure level. Moreover, the control unit 160 may control the primary variable flow regulator 103 to gradually open up to a certain value, to achieve a desired flow rate. From that time, during the fueling, the secondary variable flow regulator 151 may be controlled to slightly restrict the flow through the dispenser, as described above.

For example, the control unit 160 may control the cooling power based on a target pressure and a measured pressure inside the evaporator 105 or 106, respectively. This way, as soon as the temperature increases above a certain threshold (or the pressure of the refrigerant in the evaporator 105 or 106 increases), the cooling power may be increased by increasing the power of the compressor 109, 110, the position of the expansion valve 114, 115, and/or the power of the fan of the condenser 111, 112.

Cooling power may be increased by reducing the saturation temperature of the refrigerant inside the evaporator 105 and/or 106. This may be done by reducing the pressure of the refrigerant inside the evaporator 105 and/or 106. This may be achieved by increasing the power of the compressor 109 and/or 110, which sucks the refrigerant in gaseous form out of the evaporator and pumps it into the condenser 111, 112. Also, the expansion valve 114 and/or 115 may be adjusted to control the pressure of the refrigerant inside the evaporator.

In certain embodiments, the cooling power is increased at the start of the fueling, or shortly before the start of the fueling, so that the temperature is well controlled from the start.

In certain embodiments, the cooling system 204 may be located somewhat away from the dispenser 150. For example, the cooling system 204 may be housed in a first construction and the dispenser 150 may be a (relatively small) second construction. For example, the dispenser may be located at the side of a road so that vehicles can park right in front of it. Advantageously the dispenser is small and simple. The cooling apparatus and compression apparatus may be advantageously located at a distance from the dispenser. To avoid undesired heating of the gas on its way from the cooling unit the conduit 140 may be provided with insulation and optionally with an active cooling shield.

Such an active cooling shield may be provided, for example, by a traced pipe arrangement for carrying a gaseous substance, in particular cooled, pressurized hydrogen. The traced pipe arrangement minimizes thermal leakage between the gaseous substance flowing through the traced pipe arrangement and the ambient surroundings, thereby reducing temperature increase of the gaseous substance flowing through the traced pipe. For example, a traced pipe arrangement is provided, wherein the conduit 140 is formed by a primary pipe channel configured for carrying the gaseous substance. The traced pipe arrangement may further comprise a secondary pipe channel for carrying a coolant, wherein the secondary pipe channel extends along the primary pipe channel parallel thereto, and a shielding sheet enclosing the primary pipe channel and the secondary pipe channel. When the traced pipe arrangement is in use, the coolant flows through the secondary pipe channel for cooling the primary pipe channel and the gaseous substance flows through the primary pipe channel. As a result, the heating of the gaseous substance by ambient surroundings is compensated so that the gaseous substance maintains its temperature over longer stretches of the primary pipe channel. Furthermore, the shielding sheet enclosing the primary and secondary pipe channel is configured to provide and maintain a cooled “microclimate” in an internal/enclosed volume around the primary pipe channel by virtue of the secondary pipe channel being enclosed by the shielding sheet as well Therefore, the cooling provided by the secondary pipe channel is confined by the shielding sheet and as such a cooled microclimate surrounding the primary pipe channel is provided that minimizes heat transfer between the gaseous substance and ambient surroundings.

In an advantageous embodiment, the secondary pipe channel comprises a first coolant pipe and a second coolant pipe, wherein the primary pipe channel may be arranged between the first and the second coolant pipe. In this embodiment the first and second coolant pipe are arranged on opposing sides of the primary pipe channel so that cooling thereof is more even as it is provided on both sides. The shielding sheet then ensures that the first and second coolant pipe are able to provide a cooled microclimate around the primary pipe channel.

In an advantageous embodiment, the shielding sheet may be a metallic shielding sheet, allowing to further spreading the cooling around the primary pipe channel as provided by the secondary pipe channel, e.g. the first and second coolant pipe.

In further embodiments the shielding sheet may comprise a first sheet part and a second sheet part, wherein the first and second sheet part are in engagement for enclosing, i.e. fully enclosing, the primary pipe channel and the secondary pipe channel. This simplifies the assembly of the traced pipe arrangement as each of the first and second sheet parts can be readily positioned at least in part around the primary and secondary pipe channel. For example, in an embodiment the first sheet part may comprise two end portions and wherein the second sheet part may comprise two end portions, wherein the two end portions of the first sheet part overlap and engage the two end portions of the second sheet part. By overlapping the two end portions of both the first and second sheet parts ensures a full enclosure of the primary and secondary pipe channel and a sealed internal volume. As such the shielding sheet is able to maintain a cooled microclimate for minimizing thermal transfer between the gaseous substance and the ambient surrounds.

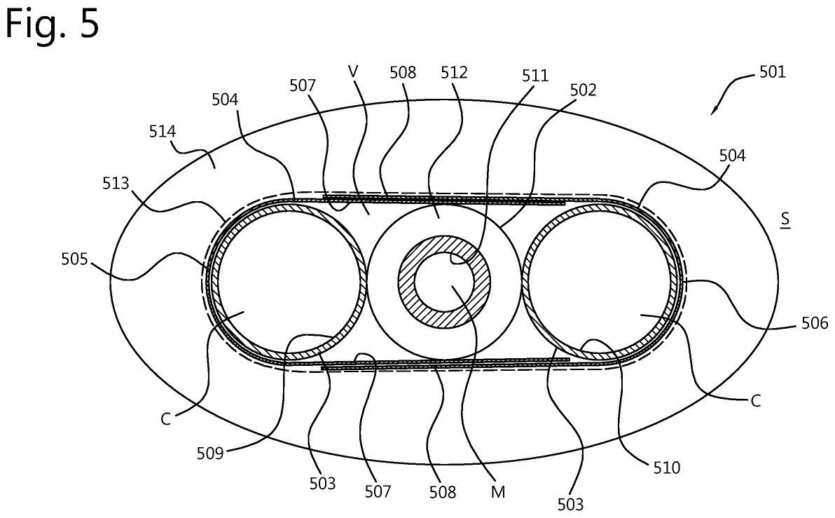

FIG. 5 shows a schematic cross sectional view of a traced pipe arrangement. This traced pipe arrangement may be applied, for example, along the trajectory of the conduit 140, 144, in particular from the heat exchanger 106 to the outlet 152, more particularly from the cooling unit 104, 204 to the distributor 150. The traced pipe arrangement 501 is configured to carry a medium, i.e. gaseous substance “M” over relatively long distances and to ensure that ambient temperatures of the ambient surroundings S have little to no impact on the temperature of the gaseous substance M carried by the traced pipe arrangement 501. For example, in case the gaseous substance M is a cooled compressed hydrogen gas to be dispensed by a hydrogen refueling station, then having to transport the cooled hydrogen over long distances may cause an unwanted rise in temperature of the hydrogen at a dispenser nozzle as considerable thermal leakage may occur during transport. The traced pipe arrangement 501 addresses the need to keep thermal leakage of the gaseous substance M to a minimum. To that end, the traced pipe arrangement 501 comprises a primary pipe channel 502 configured for carrying the gaseous substance M, a secondary pipe channel 503 for carrying a coolant “C”, e.g. a cooling fluid or gas, wherein the secondary pipe channel 503 extends along the primary pipe channel 502 parallel thereto. The traced pipe arrangement 501 further comprises a shielding sheet 504 enclosing the primary pipe channel 502 and the secondary pipe channel 503. In an exemplary embodiment the gaseous substance M is cooled compressed gaseous hydrogen.

According to the present invention, when the traced pipe arrangement 501 is in use, the coolant C flows through the secondary pipe channel 503 and the gaseous substance M flows through the primary pipe channel 502. The shielding sheet 4 enclosing the primary and secondary pipe channel 502, 503 is then configured to provide and maintain a cooled “microclimate” in an internal volume V around the primary pipe channel 502 by virtue of the secondary pipe channel 503 being enclosed by the shielding sheet 504 as well. Therefore, the cooling provided by the secondary pipe channel 503 is confined within the enclosure of the shielding sheet 504 and as such a cooled microclimate in the internal volume V surrounding the primary pipe channel 502 is provided, wherein the cooled internal volume V compensates or minimizes thermal transfer between the gaseous substance M and the ambient surroundings S. The cooled internal volume V enclosed by the shielding sheet 504 is particularly advantageous when the gaseous substance M is a hydrogen gas at a temperature below −20° C., wherein the traced pipe arrangement 501 allows the hydrogen gas to remain below −20 degrees Celsius over a desired transport distance.

As further depicted in the embodiment shown, the secondary pipe channel 503 may bear or lie against the primary pipe channel 502. In this embodiment the secondary pipe channel 503 may be in contact engagement with the primary pipe channel 502 to further improve the cooling thereof, e.g. through thermal conduction between the primary and secondary pipe channel 502, 503.

In an advantageous embodiment, the shielding sheet 504 may be a metallic shielding sheet, e.g. copper, so that the shielding sheet 504 is able to spread the cooling by the secondary pipe channel 503 around the primary pipe channel 502 through thermal conduction. As a result, the internal volume V provides for a more even spread of cooling around the primary pipe channel 502.

In an exemplary embodiment, the shielding sheet 504 comprises a first sheet part 505 and a second sheet part 506, wherein the first and second sheet part 505, 506 are in engagement for enclosing the primary pipe channel 502 and the secondary pipe channel 503. In this embodiment, the shielding sheet 504 may comprise two sheet parts 505, 506 each of which encloses at least in part the primary and secondary pipe channels 2, 503. By proper placement of each of the two sheet parts 505, 506 and proper engagement there between, a shielding sheet 504 is obtained that fully encloses the primary and secondary pipe channels 502, 503. The first and second sheet parts 505, 506 allow for convenient assembly of the shielding sheet 504 as it they can be conveniently arranged and positioned as required over long distances.

In an alternative embodiment it is conceivable that the shielding sheet 504 is a single sheet wrapped around the primary and secondary pipe channel 502, 503 and wherein opposing ends of the single sheet overlap to provide a full enclosure.

In the embodiment as depicted, it can be seen that the first sheet part 505 may comprise two end portions 507 and wherein the second sheet part 506 may also comprise two end portions 508, wherein the two end portions 507 of the first sheet part 505 overlap and engage the two end portions 508 of the second sheet part 506. By overlapping all of the end portions 507, 508 as depicted it is possible to ensure a full enclosure of the primary and secondary pipe channel 502, 503 without any gaps between the first and second sheet parts 505, 506. Also, by overlapping all of the end portions 507, 508 provides for a double layered shielding sheet 504 at points of overlap, wherein the overlap of the end portions 507, 508 may locally increase thermal shielding of the primary and secondary pipe channels 502, 503.

As further shown in FIG. 5, in an embodiment the secondary pipe channel 503 may comprise a first coolant pipe 509 and a second coolant pipe 510, wherein the primary pipe channel 502 is arranged between the first and the second coolant pipe 509, 510. In this embodiment the first and second coolant pipe 509, 510 are arranged on opposing sides of the primary pipe channel 502 so that improved distributed cooling is provided on both sides of the primary pipe channel 502. The shielding sheet 504 is arranged around the first and second coolant pipe 509, 510 and ensures that the cooled internal volume V around the primary pipe channel 502 is maintained along the length thereof.

In a further embodiment as depicted in FIG. 5, the first sheet part 505 encloses in part the first coolant pipe 509 and wherein the two end portions 507 of the first sheet part 505 extend along the primary pipe channel 502, e.g. along opposing sides thereof. Likewise, the second sheet part 506 encloses in part the second coolant pipe 510 and wherein the two end portions 508 of the second sheet part 506 extend along the primary pipe channel 502, e.g. along opposing side thereof. Note that in this embodiment the two end portions 507 of the first sheet part 505 may be in overlapping engagement with the two end portions 508 of the second sheet part 506. The first sheet part 505 may then extend or conduct the cooling provided by the first coolant pipe 509 via the two end portions 507 to the primary pipe channel 502, and wherein the second sheet part 506 extends or conducts the cooling provided by the second coolant pipe 510 via the two end portions 508 to the primary pipe channel 502. So in this way the primary pipe channel 502 may be subjected to improved cooling around its circumference even though there are only two coolant pipes 509, 510 on opposing sides of the primary pipe channel 502.

As an alternative embodiment it is conceivable that two end portions 507 of the first sheet part 505 abut the two end portions 508 of the second sheet part 506. That is, in this embodiment there is no overlapped engagement between the end portions 507, 508 but wherein the end portions 507, 508 abut along their smallest side.

In an embodiment, the first and second sheet part 505, 506, may be welded together, e.g. where the end portions 507, 508 are welded together for providing full enclosure of the primary and secondary pipe channel 502, 503.

Although not shown in the schematic cross section of FIG. 5, the first coolant pipe 509 and the second coolant pipe 510 may be fluidly connected for circulating the coolant C through the first and second cooling pipes 509, 510 in opposing direction. That is, in this embodiment the coolant C may flow through the first coolant pipe 509 along the primary pipe channel 502 in a first direction and to return through the second coolant pipe 510 in an opposing second direction, thereby creating a closed coolant loop along the primary pipe channel 502 allowing for a single end point of the traced pipe arrangement 501 for entry and exit of the coolant C.

To further insulate the primary pipe channel 502 from the ambient surroundings S, an embodiment is provided wherein the primary pipe channel 502 comprises an inner pipe 511 for carrying the gaseous substance M, e.g. cooled compressed hydrogen gas, and an inner insulating layer 512 enclosing the inner pipe 511. In this embodiment the shielding sheet 504 still provides for a cooled microclimate in the internal volume V around the primary pipe channel 502 during use, i.e. around the inner insulating layer 512 and inner pipe 511. The inner insulating layer 512 further inhibits thermal transfer between the inner pipe 505, the inner volume V and ultimately the ambient surroundings S. This ensures that the gaseous substance M can be maintained at a required temperature over long distances of the traced pipe arrangement 501.

As mentioned earlier, the secondary pipe channel 503 may bear or lie against the primary pipe channel 502. Therefore, in the aforementioned embodiment, the secondary pipe channel 503 may bear against the inner insulating layer 512, so wherein the first coolant pipe 509 and the second coolant pipe 510 may each bear against the inner insulating layer 512 to minimize the internal volume V to achieve optimal cooled conditions around the primary pipe channel 502. In an exemplary embodiment, the inner insulating layer 512 may have a thickness of at least 3 mm or more for achieving sufficiently high thermal insulation of the inner pipe 505.

It was indicated above that the shielding sheet 504 encloses the primary and secondary pipe channel 502, 503 to provide and maintain a cooled internal volume V around the primary pipe channel 502 by virtue of the secondary pipe channel 503 being enclosed by the shielding sheet 504 as well. The cooling provided by the secondary pipe channel 503 is thus confined within the enclosure of the shielding sheet 504 and as such a cooled microclimate surrounding the primary pipe channel 502 is provided to minimize thermal transfer from the ambient surroundings S when the gaseous substance M flows through the primary pipe channel 502, e.g. the inner pipe 511, over long distances.

To further ensure that a cooled environment around the primary pipe channel 502 can be maintained, an embodiment is provided wherein a tape 513 is arranged (e.g. wrapped) around the shielding sheet 504. The tape 513 provides further air tightness of the internal volume V enclosed by the shielding shield 504, allowing for improved thermal insulation of the primary pipe channel 502. In an exemplary embodiment it is conceivable that the tape 513 is an adhesive tape allowing to be wrapped tightly around the shielding sheet 504 to provide and maintain a strong airtight barrier.

To even further reduce thermal transfer between the ambient surroundings S and the gaseous substance M, an embodiment is provided as shown in FIG. 5 comprising an outer insulating layer 514 arranged around the shielding sheet 504 (or tape 513). This outer insulating layer 514 further reduces heating of the gaseous substance M when it flows through the primary pipe channel 502. In an exemplary embodiment, the outer insulating layer 514 may have a thickness of at least 25 mm or more to achieve good thermal insulation from the ambient surroundings S.

In certain embodiments, the whole trajectory of the conduit 140 from the primary variable flow regulator 103 through the heat exchanger(s) 105, 160, up to the secondary flow regulator 151 in the dispenser 150 has a single diameter.

Preferably, sharp angles are avoided in the trajectory of the conduit 140. For example, in the heat exchanger(s) 105, 106, the conduit may have a plurality of windings, in a near circular shape, to create a longer trajectory of the conduit through the heat exchanger(s) 105, 106, without creating U-turns in the conduit 140.

For example, at least one heat exchanger 105, 106 may have the shape of a hollow torus formed by a shell provided with a tube inlet for receiving the gas to be cooled and a tube outlet for discharging the gas after cooling, wherein the shell houses a tube connecting the tube inlet to the tube outlet, wherein the tube may be arranged in at least one winding through the interior of the torus. The tube may form an integral part of the conduit 140. By virtue of the torus shape, relatively large windings can be realized (which gives rise to relatively small Joule-Thomson effect) while the volume of the torus remains relatively small. The refrigerant in liquid form can form a bath inside the hollow torus, wherein some of the tube windings are immersed in the liquid refrigerant. This provides a particularly efficient heat exchange without sharp corners or U turns of the conduit 140.

For example, the shell of the heat exchanger may be provided with a refrigerant inlet for receiving a refrigerant into the interior of the refrigerant and a refrigerant outlet for removing the refrigerant from the interior of the torus. Inside the torus, the refrigerant can be in contact with the outside of the tube to extract heat from the gas inside the tube. The flow of the refrigerant through the torus, as well as the pressure of the refrigerant inside the torus, may be controlled by the compressor 109, 110 and the expansion valve 114, 115. In operation, the torus may form a bath of liquid refrigerant up to a certain level, with part of the tube below the liquid level of the refrigerant. In the top portion the refrigerant may be present in gaseous form.

In certain embodiments, a thermally conductive permeable material is provided in tight engagement with the tube, wherein the thermally conductive permeable material fluidly connects the refrigerant inlet to the refrigerant outlet. This may improve heat exchange and/or reduce the volume of refrigerant needed to fill the torus.

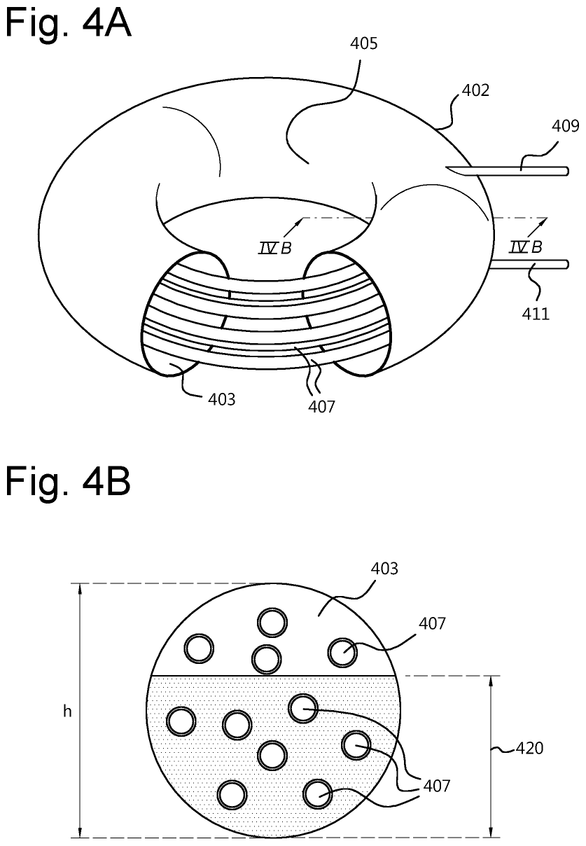

FIG. 4 shows an example of a heat exchanger having a shape of a torus. FIG. 4A illustrates a partly worked open view of a vessel for refrigerating a fluid. The vessel comprises an inner wall 405 and an outer wall 402. The inner wall 405 and the outer wall 402 may be concentric. The vessel further comprises an inner space 403 bounded by at least the inner wall 405 and the outer wall 402. The upper end of the inner wall and the upper end of the outer wall may be connected by means of an upper wall. Likewise, the lower end of the inner wall and the lower end of the outer wall may be connected by means of a lower wall. It will be understood that there need not be a clear boundary between upper/lower walls and inner/outer walls. This is particularly so for the inner space with circular cross section as illustrated in FIG. 4A and FIG. 4B. The inner space may be fluidly closed, so that the refrigerant cannot escape from the refrigeration system. The inner space 403 may have substantially a ring shape. The inner space 403 may alternatively have any other suitable shape. The vessel may comprise an inlet and an outlet (not shown) for transport of a fluid, typically refrigerant, into and out of the inner space 403. The outlet may be connectable to a compressor (not shown) and the inlet may be connectable to a condenser (not shown). The vessel may have more than one inlet and/or more than one outlet. The vessel further comprises a tube 407 forming part of the conduit 140 inside the inner space 403. The tube intersects the wall 402 of the vessel at inlet 109 and outlet 111. The tube 407 may be arranged in at least one turn around the inner wall 405. However, the tube 407 may be arranged with a plurality of turns around the inside wall 405, in a coil shape. The plurality of turns may be any suitable number such that the tube is arranged to occupy a predetermined amount of a volume of the inner space 403. However, this is not a limitation. For instance, the tube may be arranged to occupy at least two thirds of the volume of the inner space. Alternatively, he tube may have any size.

FIG. 4B shows a cross section in longitudinal direction of a part of the heat exchanger for refrigerating a fluid of FIG. 4A. The tube 407 going through the inner space 403 in several turns around the inner wall 405 is illustrated. The inner space 403 may be filled with liquid refrigerant up to a level illustrated in FIG. 4B as 420. The remainder of the inner space 403 may be filled with gaseous refrigerant. The inner space 403 may have a height illustrated in FIG. 4B as h and measured with respect to an axis to which the outer wall 402 and the inner wall 405 of FIG. 4A are concentric. For example, this concentricity axis may be oriented vertically during operation of the heat exchanger. However, this is not a limitation.

Both the heat exchangers 105, 106 may be made this way. Alternatively, one or more or all of the heat exchangers may have a different configuration, for example a tube-in-tube.

The primary variable flow regulator 103 may be positioned between the gas supply 190 and the cooling unit 204. For example, the gas supply 190 comprises a hydrogen compressor. The secondary variable flow regulator 151 may be positioned in the dispenser 150. The primary variable flow regulator 103 may have a larger pressure drop than the secondary variable flow regulator 151, and therefore the primary variable flow regulator 103 may cause a larger Joule-Thomson effect than the secondary variable flow regulator 151. As a result of the position of the primary variable flow regulator 103, the temperature increase of the gas caused by the JT effect will be undone by the cooling unit 204. Therefore, the Joule-Thomson effect caused by the primary variable flow regulator 103 does not affect the temperature of the gas distributed by the dispenser 150.

In certain embodiments, the cooling system 204 comprises two or more phases, as illustrated in FIG. 2. Each phase may have its own heat exchanger. In the first phase, the gas is cooled down to a first temperature and in the second phase the gas is cooled down to a second temperature lower than the first temperature. For example, the second temperature is in the range of allowed temperatures for gas distribution, e.g. −40 degrees Celsius. The first phase can cool the gas to an intermediate temperature of e.g. −18 degrees Celsius. Because the gas has been heated by the primary variable flow regulator 103, it is especially advantageous to apply this two-phase cooling. The overall energy efficiency of such a two (or more) phase cooling system may be better than that of a single phase cooling system. For example, the saturation point of the refrigerant in the first phase heat exchanger may be set to −18 degrees Celsius, so that the gas leaving the first phase heat exchanger also has this temperature, and the saturation point of the refrigerant in the second phase heat exchanger may be set to −40 degrees Celsius, so that the gas leaving the first phase heat exchanger also has this temperature. With a single heat exchanger it would be more difficult to achieve this and more refrigerant would need to be kept at a low temperature of −40. Existing systems are known to over-compensate by using a refrigerant that has a temperature lower than the desired temperature of the gas, for example the refrigerant is brought to a temperature of −50 degrees Celsius while the gas is only cooled down to −40 degrees Celsius. This approach costs much more energy, as it costs energy to keep the refrigerant at a lower temperature.

The torus shape allows a relatively long trajectory of the tube through the heat exchanger without U turns, so that the gas can reach the same temperature, or almost the same temperature, as the refrigerant in many circumstances. Moreover, by the two-phase approach the temperature drop in each phase is much lower, which also makes it is easier for the gas to reach the same temperature as the refrigerant, in particular inside a torus shaped heat exchanger.

As described above, the cooling system 204 may have two or more stages. For example, stage 1 may be a minus 18 C system and stage 2 may be a minus 40 C system. The evaporating temperature of each stage may be controlled (e.g. by the control unit 160) by pressure regulation of the evaporator by using an inverter on the compressors. In certain embodiments, the system comprises a flow meter (e.g. mass flow meter 120), and one or more thermometers; for example, a thermometer before the inlet 116 of the first phase heat exchanger 105, and a thermometer after the outlet 117, 118 of each heat exchanger 105, 106 that the gas flows through. The control unit 160 may calculate, based on the mass flow and the measured temperature(s), the most efficient evaporating temperature of the refrigerant in each stage (e.g. stage 1 and stage 2). The inverter of the compressors and the electronic expansion valves may be set based on these conditions. For example, if cooling demand increases, the evaporating temperature of the first stage may be decreased first, so that the lowest evaporation temperature (of the last phase) is only lowered if lowering the earlier phase(s) is not sufficient.

In certain embodiments, the cooling system may enter an idle mode when no fueling takes place. For example, the idle mode may be entered when the fueling is completed or when the nozzle is put back in the holder, which holder may be provided for that purpose in the dispenser 150. For example, during the idle mode the compressor power is reduced to save power, as no to little gas is flowing through the conduit. In certain embodiments, the control unit 160 may detect that the nozzle 152 is disconnected from its holder. Alternatively or additionally, the control unit 160 may detect that the nozzle 152 is connected to a vehicle 250 or that a fueling switch is set. In response to either detection, the system may end the idle mode and switch to refuel mode. In this case, the compressors 109, 110 and/or the expansion valves 114, 115 may have a different setting so that the cooling power is increased already before fueling begins, to prepare for the flow of the gas that will come.

The heat exchangers 105, 106 may be configured to run on the highest evaporation pressure that is possible, given the conditions of the gas during refueling. The last phase heat exchanger generally operates with an evaporation temperature equal to or slightly lower (e.g. 0.5 to 2 degrees Celsius lower, preferably one degree Celsius lower) than the desired target temperature of the gas. For example, the heat exchanger may operate at an evaporating temperature of −41 degrees Celsius for a target temperature of −40 degrees Celsius. The preceding phases may operate at temperatures that are just low enough to allow the last phase heat exchanger 106 to achieve the target temperature of the gas at the given evaporating temperature. For example, the first phase heat exchanger 105 may operate at an evaporating temperature of −18 degrees Celsius by default. However, in case the temperature of the gas at the outlet 118 of the last phase heat exchanger 106 is greater than the target temperature, the first phase heat exchanger 105 may be set by the control unit 160 to operate at a lower evaporating temperature (e.g. a temperature below −18 degrees Celsius), to perform stronger pre-cooling of the gas before the gas reaches the last phase heat exchanger 106.

If that is not sufficient, the last phase heat exchanger 106 may be set to run on an evaporation temperature that is lower than the default evaporating temperature of the last phase evaporator 106, for example it will be set from the default −41 degrees Celsius to e.g. −50 degrees Celsius, depending on the necessary amount of cooling. This procedure may avoid the need to reduce the lowest evaporating temperature of the system as much as possible, so that the overall energy consumption of the cooling system 204 is reduced.

In certain embodiments, lowest temperature phases, e.g. the heat exchanger(s) 106 operating at temperature(s) below −25 or −30 degrees Celsius, in particular below −40 degrees Celsius, can run on propylene as refrigerant. In certain embodiments, the heat exchanger(s) 105 operating at relatively higher temperatures above −25 or −30 degrees Celsius, in particular above −20 degrees Celsius, can run on propane as a refrigerant. An alternative for propane may be Freon. It will be understood that these refrigerants are only presented as examples. Other types of refrigerant may be alternatively employed.

To make sure that the refrigerant, in particular in the heat exchanger(s) operating at lower temperatures and/or using e.g. propylene as refrigerant, will not run in vacuum and to be sure that the hydrogen will not become too cold, there may be a hotgas bypass installed on the heat exchanger, which comprises a passage (not illustrated) from the outlet of the compressor 110 to the refrigerant inlet 119 of the heat exchanger 106. For example, if the evaporating pressure inside the heat exchanger 106 runs below a certain threshold, a switch on that shortcut passage may open up and inject high pressure hotgas into the heat exchanger 106. This switch may be controlled by the control unit 160 or by a local regulator of the expansion valve.

Before fueling starts, for example once the nozzle 152 is connected to the vehicle 250, the control unit 160 may receive information from the vehicle. The pressure and temperature in the gas tank of the vehicle may be read by a sensor of the vehicle and sent from the vehicle to the control unit 160 of the cooling system.

In certain embodiments, the gas supply unit 190 has the gas available at a plurality of different pressure levels; for example, the gas supply 190 comprises a plurality of gas vessels, each vessel having its own pressure. The control unit 160 may determine one of the available pressure levels for delivery. For example, the control unit 160 may select the next higher available pressure compared to the pressure of the gas tank 252 in the vehicle 250. Alternatively, another system selects the pressure that will be delivered and reports it to the control unit 160. Moreover, the control unit 160 may be informed of the temperature of the gas that will be supplied to the cooling unit 204.

Based on the determined pressure (and temperature) of the supplied gas, the control unit 160 may determine the optimal settings for the cooling unit 204. In particular, the control unit 160 may set the power of the compressor(s) 109, 110, and set the level to which the expansion valve(s) 114, 115 are opened. Also the target pressure (and evaporating temperature) of the refrigerant in the heat exchanger(s) 105, 106 may be set based on the determined pressure and/or temperature of the supplied gas. The cooling system may calculate the necessary cooling capacity at the different stages and setup the most efficient values of the inverter and electronic valves.

In certain embodiments, the system comprises an ambient temperature sensor. The control unit 160 may receive an indication of the ambient temperature. The setting of the condenser(s) 111, 112 may be set based on the ambient temperature. Moreover, the temperature of the supplied gas may be estimated based on the ambient temperature, and the necessary cooling power can be derived therefrom.

If the capacity of the compressor that is necessary to cool the gas in the conduit 140 is lower than the minimum inverter output of the compressor, the condenser can run on a higher condensation temperature. For example the control unit 160 can control the inverter of the condenser, so that the inverter of the condenser fan has a lower output. The compressor will then run on a higher condensation temperature and will be in run mode. Alternatively, the optional hotgas bypass can also be used to keep the compressor running while the system is in refueling mode. Such a hotgas bypass comprises a passage (not illustrated) from the outlet of the compressor 110, 109 to the refrigerant inlet 119 of the heat exchanger 106, 105. By injecting the compressed hotgas into the evaporator without allowing the hotgas to condense, the pressure and temperature in the evaporator can be increased so that the amount of vapor that is needed to allow the compressor to continue running safely is achieved even in case of little cooling demand. Preferably, to reduce energy consumption, the use of the hotgas bypass is reduced as much as possible.

To ensure that the refrigerant arrives at the compressor 109, 110 in gaseous form, an additional heat exchanger 107, 108 may be installed in the suction line of the compressor 109. This additional heat exchanger 107, 108 may comprise a plate heat exchanger, for example. This additional heat exchanger 107, 108 exchanges the heat of the liquid refrigerant from the condenser 111, 112 with the suction gasses from the heat exchanger 105, 106. In this way the superheat of the suction gasses moving towards the compressor 109, 110 is guaranteed. It allows to have a smaller superheat from the heat exchangers 105, 106, so that the system can be more efficient.

The system may comprise an intermediate cooling system to cool down the intermediate stages of the hydrogen compressors of the gas supply 190. The outlets of the hydrogen compressors may be connected to a tube that extends through the heat exchanger or heat exchangers of the intermediate cooling system. For example, the intermediate cooling system comprises two heat exchangers, which may be torus-shaped, although other shapes are not excluded. The first stage heat exchanger of the intermediate cooling system may be connected to a drycooler and the heat may exchange with ambient air with a finned aircooler. After this stage the hydrogen flows further through the tube which extends through the second stage heat exchanger, which may also be torus shaped. This second heat exchanger may be an evaporator running on a refrigerant, such as propane. The system may be designed to work under conditions of e.g. a certain maximum ambient temperature, such as 40 degrees Celsius or 50 degrees Celsius. The hydrogen may be cooled down to the specs of the hydrogen compressor specifications. The intermediate cooling system and the hydrogen compressor system may communicate about the most efficient settings. This may be managed by the control unit 160, for example. A lower outlet temperature of the intermediate cooling system may result in a more efficient compressing performance. However, more cooling will result in a higher energy consumption of the intermediate cooling system. Therefore the control unit 160 may receive state parameters of the system including measurements, and determine optimal setting for the intermediate cooling system 205 and the compressors of the gas supply 190. The conduit for the gas from the gas supply 190 through the intermediate cooling system, including one or more heat exchangers and back to the gas supply 190 may have a constant diameter, apart from any fluid components.

The features and variations described herein in with reference to FIG. 2 may also be similarly applied to the embodiment described herein with reference to FIG. 1, and vice versa.

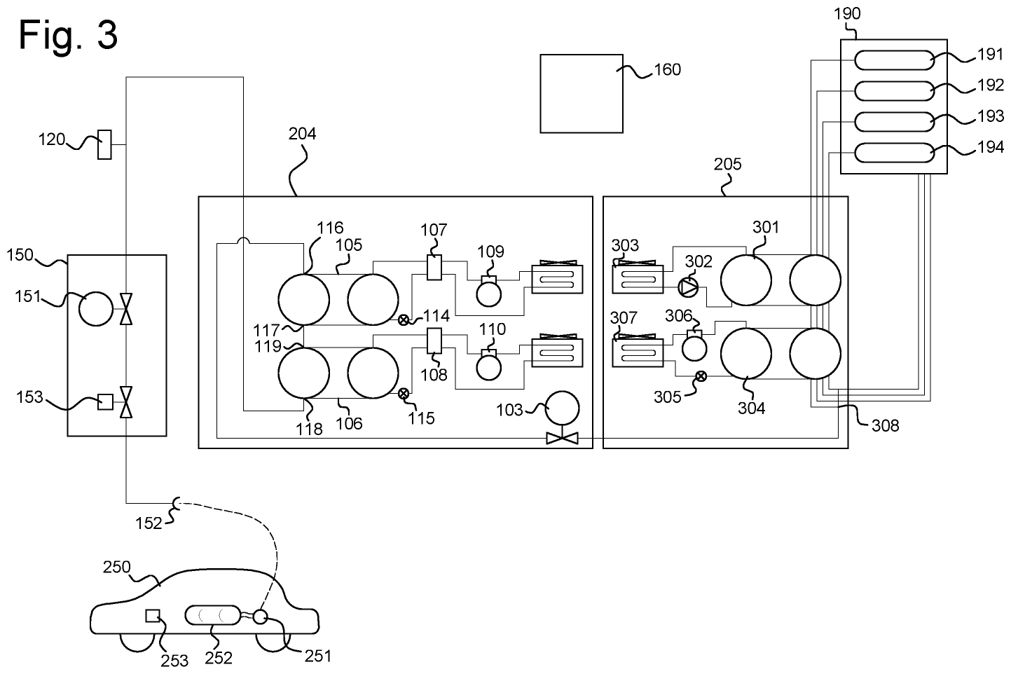

FIG. 3 shows a diagram of a fueling station in greater detail. The items similar to the items appearing in FIG. 2 have been indicated with the same reference numerals. Their function can be similar to what is described hereinabove. The features and variations described hereinabove can also be applied to the example shown in FIG. 3, and vice versa.

The gas supply unit 190 may comprise one or more compressors (not illustrated) to compress the supply gas to desired pressure levels, which may be stored in gas vessels 191, 192, 193, 194. In this process the gas may be heated. For this and other reasons it may be useful to perform cooling of the gas in the gas supply unit 190. Also, the gas provided by the gas supply unit 190 may be very hot, so that it may be suitable to provide pre-cooling before the gas flows through the primary variable flow regulator 103 and the heat exchanger(s) 105, 106.

To this end, the cooling system shown in FIG. 3 comprises a intermediate cooling unit 205, designed to cool the gas. Generally, the intermediate cooling unit 205 cools the gas down to a target temperature that is greater than the target temperature of the cooling unit 204. For example, the intermediate cooling unit 205 may cool the gas down to −6 degrees Celsius.

The intermediate cooling unit 205 may be implemented as a multi-stage cooling system. For example, the first stage of the intermediate cooling unit 205 comprises a heat exchanger 301 and a circulation of a medium (e.g. glycol) by a pump 302 along the heat exchanger 301 to cool the gas and a second heat exchanger 303 to cool the medium by means of air. For example, the first stage heat exchanger 301 may be configured to cool the gas down to about +40 degrees Celsius.

For example, the second stage of the intermediate cooling unit 205 comprises a heat exchanger 304, a compressor 306, a condenser 307, and an expansion valve 305. The second stage may be configured to circulate a refrigerant, e.g. Freon or propane, involving phase change of the medium inside the heat exchanger 304 (which is an evaporator) and the condenser 307.

The gas supply unit 190 may comprise a plurality of gas vessels 191, 192, 193, 194. Each vessel may have a different pressure. For example, vessel 191 may store the gas at around 150 bar, vessel 192 may store the gas at around 300 bar, vessel 193 may store the gas at around 600 bar, and vessel 194 may store the gas at around 1000 bar. The gas at a first pressure level (e.g. 150 bar) may flow from the corresponding vessel 191 to a compressor (not illustrated) that compresses the gas up to the next pressure level, after which the gas flows through a tube through the intermediate cooling system 205, and flows through a tube back to the gas supply 190 e.g. to be stored in the next level gas vessel 192. Each outlet of a vessel 191, 192, 193 may thus be connected via a tube through intermediate cooling system 204 to the next level gas vessel 192, 193, 194, respectively. Using this configuration, all the vessels may be filled with gas up to their corresponding pressure.

The intermediate cooling unit 205 may comprise one or more heat exchangers 301, 304 to cool down the gas after each compression step. In the example shown, a first heat exchanger 301 cools down the gas to a first temperature (e.g. around ambient temperature) and the second heat exchanger 304 cools down the gas to a second temperature, suitable for storage in the gas supply 190. The multiple tubes with the different pressures may go through each heat exchanger 301, 304 of the intermediate cooling unit 205 together, so that each pressure value has separate tubing through the same heat exchanger(s).

After cooling by the intermediate cooling unit 205, the gas may return to the gas supply unit 190 for storage or further compression. Alternatively, during fueling, switch 308 may be controlled to, in accordance with the desired pressure of gas supply, selectively connect one selected outlet of the outlets of the heat exchanger 304 to the cooling unit 204, so that the gas at a desired pressure reaches the primary variable flow regulator 103.

A high outlet temperature of the hydrogen compressor (provided, for example, in the gas supply unit 190) may result in compressor damage. Therefore the maximum outlet temperature of the intermediate cooling system can be controlled by the intermediate cooling system. Once the compressor outlet temperature of the gas supply 190 becomes too high (e.g. higher than a pre-determined threshold), the intermediate cooling system can run on a lower evaporating temperature. As a result, the inlet temperature of this hydrogen compressor may be reduced and the outlet temperature as a result as well. For example, the control unit 160 may be configured to set the cooling power and/or the output temperature of the intermediate cooling unit 205 based on an outlet temperature of a compressor of the gas supply 190.

The control unit 160 may be implemented as a programmable logic circuit (PLC), or as a suitably programmed computer, for example.

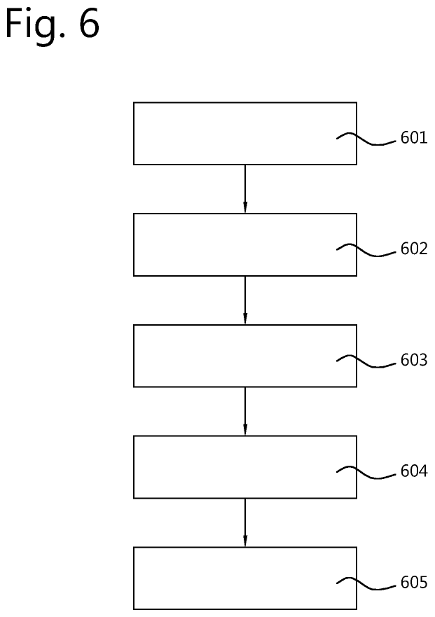

FIG. 6 illustrates a method of inline cooling for controlled delivery of a gaseous substance, such as hydrogen. The method may comprise step 601 of transporting the gaseous substance, in a pressurized form, from a gas supply unit (190), through a conduit (140) to an outlet (152). The method may further comprise step 602 of regulating a flow through the conduit by a primary variable flow regulator (103) arranged along the conduit (140); The method may further comprise step 603 of extracting heat from the gaseous substance inside the conduit by at least one heat exchanger (106) arranged along the conduit (140) in between the primary variable flow regulator (103) and a secondary variable flow regulator (151). The method may further comprise step 604 of regulating the flow through the conduit further by the secondary variable flow regulator (151) arranged along the conduit (140). The method may further comprise, controlling (605), by a control unit 160, the primary variable flow regulator 103 and the secondary variable flow regulator 151, based on a demand for the gaseous substance at the fueling dispenser. This controlling may be further based on measurement data, obtained from a sensor along the conduit 140, for example flow meter 120 and/or a temperature and/or pressure sensor. The method may be modified or extended based on the features disclosed hereinabove.

With reference to FIGS. 1, 2 and 3, as described above, the fueling station 100 may comprise a primary flow regulator 103 for regulating the flow of fuel through the conduit 140. The primary flow regulator 103 may be configured to regulate the mass flow of the fuel through the conduit. Moreover, the primary flow regulator 103 is variable, so that the flow of the fuel through the conduit can be gradually adapted according to the circumstances. The setting of the primary flow regulator may, for example, be controlled by the control unit 160. The primary flow regulator 103 may be variable in multiple steps or continuously.

Preferably the primary flow regulator 103 is continuously variable.

Alternatively, the primary flow regulator 103 may be step-wise variable, so that the flow of the fuel through the conduit can be gradually adapted according to the circumstances. In case the primary flow regulator is step-wise variable, the primary flow regulator may have any number of fixed positions, each position corresponding to a particular amount of flow restriction. Such a flow regulator may be implemented, for example, by a plurality of valves arranged in parallel across the cross section of the conduit 140.

For example, the primary flow regulator may have four positions: fully closed, ⅓ open, ⅔ open, and fully open. Such a flow regulator may be implemented, for example, by three equally-sized valves arranged in parallel. Alternatively, such a flow regulator may be implemented by two valves: a first valve having a surface area of ⅓ of the cross section of the conduit, and a second valve having a surface area of ⅔ of the cross section of the conduit.

For example, the primary flow regulator 103 and/or the secondary flow regulator 151 may be a variable area control device or a mass flow control valve.

In a preferred embodiment, the primary flow regulator is step-wise variable and the secondary flow regulator is continuously variably.

Alternatively, the secondary flow regulator may be step-wise variable. For example, the secondary flow regulator may be step-wise variable in smaller steps than the primary flow regulator. For example, if the primary flow regulator is configurable in steps of ⅓ of the conduit cross section, the secondary flow regulator may be configurable in steps of 1/10 of the conduit cross section.

An aspect of the invention provides an inline cooling system for controlled delivery of a gaseous substance, in particular hydrogen, comprising
a conduit for transporting the gaseous substance from a gas supply unit to an outlet, wherein the gas supply unit is configured to supply the gaseous substance in a pressurized form;
at least one heat exchanger arranged along the conduit, wherein the heat exchanger is configured to extract heat from the gaseous substance inside the conduit,
a valve to open and close the conduit in between the heat exchanger and the outlet;
a switching circuit to selectively fluidly connect a selected gas storage supply among a plurality of gas storage supplies of the gas supply unit to the conduit; and
a control unit configured to control to close the valve, select a gas storage supply having a lower pressure than a pressure of the gaseous substance inside the conduit, and, while the valve is closed, control the switching circuit to fluidly connect the selected gas storage supply to the conduit.

This helps to avoid an undesired high amount of gas flow and/or heat effects when opening the valve.

The system may be for filling a gas tank, wherein the outlet comprises a nozzle to which the gas tank can be fluidly connected, and the control unit is configured to control to perform the step of controlling to close the valve when filling the gas tank is completed. This way the pressure in the conduit may be prepared for a next gas tank.

The step of controlling the switching circuit to fluidly connect the selected gas storage supply to the conduit may be performed in between successive operations of filling a first gas tank and filling a second gas tank to be connected to the nozzle, wherein the first gas tank is different from the second gas tank. This way the pressure in the conduit may be prepared for a next gas tank in between fillings of gas tanks that may be connected to the nozzle subsequently.

The step of controlling the switching circuit to fluidly connect the selected gas storage supply to the conduit may be performed directly after completion of the operations of filling the first gas tank (252) and controlling to close the valve. This way the conduit is not kept under a high pressure unnecessarily.

The control unit may be configured to receive a pressure value of the inside of the second gas tank and perform the selecting of the gas storage supply based on the pressure inside the selected gas storage supply and the pressure value of the inside of the second gas tank. This way the pressure inside the conduit may be adapted to the pressure in the gas tank before fluidly connecting them by opening the valve.

The inline cooling system may be for refueling a fuel-cell based electric device, for example a fuel-cell based electric vehicle, and the gas tank may be the gas tank of the fuel-cell based electric device. This allows implementation of e.g. a hydrogen refueling station.

The system may further comprise
a primary variable flow regulator arranged along the conduit to regulate a flow through the conduit;
a secondary variable flow regulator arranged along the conduit to regulate the flow through the conduit; and
wherein the at least one heat exchanger is arranged along the conduit in between the primary variable flow regulator and the secondary variable flow regulator.

This helps to regulate the flow through the conduit as elaborated hereinabove. By virtue of the lowering of the pressure before fluidly connecting the gas tank to the conduit, there is no inadvertently high flow through the variable flow regulators when opening the valve.

The primary variable flow regulator may be configured to, in a fueling mode of operation, restrict the flow of the fuel more than the secondary variable flow regulator does.

The secondary variable flow regulator may be configured to, in an initialization mode, gradually open until a pressure inside the conduit has equalized with a pressure connected to the outlet.

The conduit may have a first diameter throughout the heat exchanger and a second diameter outside the heat exchanger, wherein the first diameter is equal to the second diameter.

The conduit may have a fixed diameter throughout from the primary flow regulator through the heat exchanger to the secondary flow regulator.

The conduit may have the same fixed diameter in between any pair of fluid components arranged subsequently along the conduit from the pressurized supply to an outlet, wherein the pair of fluid components comprises two fluid components, wherein each fluid component comprises a valve, a flow regulator, or a measurement device.

A length of a portion of the conduit in between the heat exchanger and the secondary flow regulator may be greater than 10 meters.

The system may further comprise a binary valve to selectively close the conduit in between the secondary variable flow regulator and the outlet.

The system may further comprise
a cooling apparatus comprising a first housing enclosing the heat exchanger and the primary flow regulator; and
a dispenser for dispensing the gaseous substance, wherein the dispenser comprises a second housing different from the first housing, the second housing enclosing the secondary flow regulator,
wherein the conduit extends through the cooling apparatus and through the dispenser, and
wherein the cooling apparatus and the dispenser are disjunct devices.

The cooling apparatus and the dispenser may be firmly connected to a ground, wherein a distance between the heat exchanger and the dispenser is greater than 10 meters.

The system of may further comprise an active cooling element that extends along the part of the conduit in between the cooling apparatus and the dispenser.

The system may further comprise a control unit configured to control the primary variable flow regulator and the secondary variable flow regulator, based on a demand for the gaseous substance at the fueling dispenser.

The control unit may be configured to control the primary variable flow regulator to restrict the flow by a first fraction and control the secondary variable flow regulator to restrict the flow by a second fraction, based on a demand for the gaseous substance at the fueling dispenser, wherein the second fraction is less than or equal to 10%, preferably less than or equal to 1%, of the first fraction.

The primary flow regulator and the secondary flow regulator may be configured to cause a pressure drop of the gaseous substance at the primary flow regulator to be greater than a pressure drop of the gaseous substance at the secondary flow regulator.

The at least one heat exchanger may have a shape of a torus.

A hydrogen refueling station may be provided for refueling fuel-cell based electric devices, in particular vehicles, comprising the inline cooling system set forth.

According to another aspect of the invention, a method of inline cooling for controlled delivery of a gaseous substance, in particular hydrogen, is provided the method comprising
transporting the gaseous substance, in a pressurized form, from a gas supply unit, through a conduit to an outlet;
opening a valve arranged along the conduit in between the heat exchanger and the outlet;
extracting heat from the gaseous substance inside the conduit by at least one heat exchanger arranged along the conduit in between the primary variable flow regulator and a secondary variable flow regulator while the valve is open;
closing the valve;
selectively fluidly connecting a selected gas storage supply among a plurality of gas storage supplies of the gas supply unit to the conduit;
selecting a gas storage supply having a lower pressure than a pressure of the gaseous substance inside the conduit; and
while the valve is closed, controlling a switching circuit to fluidly connect the selected gas storage supply to the conduit.

With reference to any of FIGS. 1, 2, and 3, when the filling of a vehicle is completed, the tank 252 of the vehicle and the conduit 140 contain high pressure gaseous substance. When the fueling is complete, before the vehicle is disconnected, the valve 153 may be closed in order to prevent leakage of gaseous substance. However, the high pressure in the conduit 140 remains. When a next vehicle is connected to the dispenser to be refueled, the valve 153 is opened again. However, a large pressure difference between the conduit and the gaseous substance tank of the car 252 may cause undesired effects when opening the conduit to the gas tank 252, e.g. by opening the valve 153. For example, the equalization of the pressure that would occur, may cause an undesired temperature rise of the gaseous substance. To prevent this, in certain embodiments, the pressure in the conduit 140 is reduced in between refueling of two subsequent vehicles. The operations involved in this pressure reduction may be controlled by the control unit 160. Several examples of this pressure reduction are described hereinafter. It will be understood that these examples may be applied to any of the embodiments described hereinabove. Moreover, the feature of pressure reduction of the gas in the conduit 140 may be implemented regardless of the presence of the primary flow regulator and secondary flow regulator. That is, although the primary flow regulator and secondary flow regulator are preferably implemented as described in the present disclosure, they may be omitted in certain embodiments. The pressure reduction feature may alternatively be implemented in e.g. a refueling station that uses another flow regulation method.

The pressure reduction may be performed in between refueling operations, in particular when the conduit 140 is closed at the dispenser 150 (close to the nozzle 152), for example by closing valve 153 and/or secondary flow regulator 151. Pressure reduction may be achieved by allowing some of the gaseous substance to be released to the environment, however that would cause a waste of precious material. Preferably, the conduit 140 is equalized with one of the gas storage facilities, for example gas tanks 191, 192, 193, 194, of the gas supply. For that purpose, a gas storage facility having a desired lower pressure can be selected. The gas supply 190 may comprise a switching circuit to fluidly connect a selected gas storage facility, for example one of the gas tanks 191, 192, 193, 194, to the inlet 113 of the cooling unit 204. This switching circuit may be used to lower the pressure in the conduit by fluidly connecting a selected gas storage facility with a lower pressure to the inlet 113 of the cooling unit 204. For example, the control unit 160 may be configured to control the switching circuit to fluidly connect a gas tank 191 with a selected pressure level to the conduit 140, wherein the pressure level in the selected gas storage facility is lower than the pressure inside the conduit 140.

In a first example, the pressure reduction operation is performed to achieve a predetermined pressure. For example, a fixed one of the available gas tanks 191, 192, 193, 194, which is kept in a suitable pressure range, may be equalized with the conduit in the way described above. Thus, the pressure inside the conduit 140 is brought to the suitable pressure range in between successive refueling operations. This kind of pressure reduction operation can be performed at any time between two successive refueling operations, preferably directly after completing a refueling operation.

In a second example, the pressure reduction operation is performed directly before a new refueling operation. For example, the control unit 160 is configured to receive an indication of the pressure in the gas tank 252 of the vehicle, while the valve 153 is still closed. The control unit 160 is configured to select a suitable gas storage facility for equalizing, based on the pressure inside the gas storage facilities and the pressure in the gas tank 252 of the vehicle. For example, the control unit may be configured to select the gas storage facility (e.g. 192) that has the lowest pressure that lies above the pressure inside the gas tank 252 of the vehicle. The control unit 160 may be configured to receive the indication of the pressure in the gas tank 252 of the vehicle by means of a communication signal from the vehicle. Alternatively, a pressure sensor may be provided in between the valve 153 and the nozzle 152.

In a third example, the first example and the second example are combined. That is, after a refueling operation is completed, the pressure inside the conduit 140 may be lowered to a suitable default value, by equalizing with a first selected gas storage facility at a first pressure. Later, shortly before a new refueling operation for the next vehicle starts, the pressure inside the conduit 140 may be brought to a pressure value suitable for refueling the next vehicle, by equalizing with a second selected gas storage facility at a second pressure, wherein the second pressure is different from the first pressure. In the third example, the second pressure may be greater (or lower) than the first pressure. This example has the advantage that in between refueling operations, when the cooling unit 204 is idle, the pressure in the conduit 140 is lowered. Moreover, the pressure in the conduit 140 is brought to an optimal value to prepare for a new refueling operation.

Some or all aspects of the invention, in particular the program for the control unit 160, may be suitable for being implemented in form of software, in particular a computer program product. The control unit 160 itself may be implemented, for example, in form of a microcontroller, a computer processor, a computer, or a programmable logic array. The computer program product may comprise a computer program stored on a non-transitory computer-readable media. Also, the computer program may be represented by a signal, such as an optic signal or an electro-magnetic signal, carried by a transmission medium such as an optic fiber cable or the air. The computer program may partly or entirely have the form of source code, object code, or pseudo code, suitable for being executed by a computer system. For example, the code may be executable by one or more processors.

The examples and embodiments described herein serve to illustrate rather than limit the invention. The person skilled in the art will be able to design alternative embodiments without departing from the spirit and scope of the present disclosure, as defined by the appended claims and their equivalents. Reference signs placed in parentheses in the claims shall not be interpreted to limit the scope of the claims. Items described as separate entities in the claims or the description may be implemented as a single hardware or software item combining the features of the items described.

Certain subject-matter is disclosed in the following clauses.
1. An inline cooling system for controlled delivery of a gaseous substance, in particular hydrogen, comprising
   a conduit (140) for transporting the gaseous substance from a gas supply unit (190) to an outlet (152), wherein the gas supply unit (190) is configured to supply the gaseous substance in a pressurized form;
   a primary variable flow regulator (103) arranged along the conduit (140) to regulate a flow through the conduit;
   a secondary variable flow regulator (151) arranged along the conduit (140) to regulate the flow through the conduit; and
   at least one heat exchanger (106) arranged along the conduit (140) in between the primary variable flow regulator (103) and the secondary variable flow regulator (151), wherein the heat exchanger (106) is configured to extract heat from the gaseous substance inside the conduit.
2. The system of clause 1, wherein, in a fueling mode of operation, the primary variable flow regulator (103) is configured to, in a fueling mode of operation, restrict the flow of the fuel more than the secondary variable flow regulator (151) does.
3. The system of any preceding clause, wherein the secondary variable flow regulator is configured to, in an initialization mode, gradually open until a pressure inside the conduit (140) has equalized with a pressure connected to the outlet (152).
4. The system of clause 1, wherein the conduit (140) has a first diameter throughout the heat exchanger (106) and a second diameter outside the heat exchanger (106), wherein the first diameter is equal to the second diameter.
5. The system of clause 4, wherein the conduit (140) has a fixed diameter throughout from the primary flow regulator (103) through the heat exchanger (106) to the secondary flow regulator (151).
6. The system of clause 4, wherein the conduit (140) has the same fixed diameter in between any pair of fluid components arranged subsequently along the conduit (140) from the pressurized supply (190) to an outlet (152), wherein the pair of fluid components comprises two fluid components, wherein each fluid component comprises a valve, a flow regulator, or a measurement device.
7. The system of clause 1, wherein a length of a portion (144) of the conduit (140) in between the heat exchanger (106) and the secondary flow regulator (151) is greater than 10 meters.
8. The system of clause 1, further comprising a binary valve (153) to selectively close the conduit (145) in between the secondary variable flow regulator (151) and the outlet (152).
9. The system of clause 1, further comprising
   a cooling apparatus (101) comprising a first housing enclosing the heat exchanger (106) and the primary flow regulator (103); and
   a dispenser (150) for dispensing the gaseous substance, wherein the dispenser (150) comprises a second housing different from the first housing, the second housing enclosing the secondary flow regulator (151),
   wherein the conduit (140) extends through the cooling apparatus (100) and through the dispenser (150), and
   wherein the cooling apparatus (101) and the dispenser (150) are disjunct devices.
10. The system of clause 9, wherein the cooling apparatus (101) and the dispenser (150) are firmly connected to a ground, wherein a distance between the heat exchanger (106) and the dispenser (151) is greater than 10 meters.
11. The system of clause 9 or 10, further comprising an active cooling element that extends along the part (144) of the conduit (140) in between the cooling apparatus (101) and the dispenser (150).
12. The system of clause 1, further comprising a control unit (160) configured to control the primary variable flow regulator and the secondary variable flow regulator, based on a demand for the gaseous substance at the fueling dispenser.
13. The system of clause 12, wherein the control unit (160) is configured to control the primary variable flow regulator to restrict the flow by a first fraction and control the secondary variable flow regulator to restrict the flow by a second fraction, based on a demand for the gaseous substance at the fueling dispenser, wherein the second fraction is less than or equal to 10%, preferably less than or equal to 1%, of the first fraction.
14. The inline cooling system of clause 1, wherein the primary flow regulator (103) and the secondary flow regulator (151) are configured to cause a pressure drop of the gaseous substance at the primary flow regulator (103) to be greater than a pressure drop of the gaseous substance at the secondary flow regulator (151).
15. The inline cooling system of clause 1, wherein the at least one heat exchanger has a shape of a torus.
16. A method of inline cooling for controlled delivery of a gaseous substance, in particular hydrogen, the method comprising
   transporting (601) the gaseous substance, in a pressurized form, from a gas supply unit (190), through a conduit (140) to an outlet (152);
   regulating (602) a flow through the conduit by a primary variable flow regulator (103) arranged along the conduit (140);
   extracting (603) heat from the gaseous substance inside the conduit by at least one heat exchanger (106) arranged along the conduit (140) in between the primary variable flow regulator (103) and a secondary variable flow regulator (151); and
   regulating (604) the flow through the conduit further by the secondary variable flow regulator (151) arranged along the conduit (140).

Certain subject-matter is disclosed in the following examples.
1. An inline cooling system for controlled delivery of a gaseous substance, in particular hydrogen, comprising
   a conduit (140) for transporting the gaseous substance from a gas supply unit (190) to an outlet (152), wherein the gas supply unit (190) is configured to supply the gaseous substance in a pressurized form;
   at least one heat exchanger (106) arranged along the conduit (140), wherein the heat exchanger (106) is configured to extract heat from the gaseous substance inside the conduit,
   a valve (153, 151) to open and close the conduit (145) in between the heat exchanger (106) and the outlet (152);
   a switching circuit to selectively fluidly connect a selected gas storage supply among a plurality of gas storage supplies (191, 192, 193, 194) of the gas supply unit (190) to the conduit (140); and
   a control unit (160) configured to control to close the valve (153, 151), select a gas storage supply (191) having a lower pressure than a pressure of the gaseous substance inside the conduit (140), and, while the valve (153, 151) is closed, control the switching circuit to fluidly connect the selected gas storage supply (191) to the conduit (140).
2. The system of example 1, wherein the system is for filling a gas tank (252), wherein the outlet (152) comprises a nozzle to which the gas tank (252) can be fluidly connected, and the control unit is configured to control to perform the step of controlling to close the valve (153, 151) when filling the gas tank (252) is completed.
3. The system of example 2, wherein the step of controlling the switching circuit to fluidly connect the selected gas storage supply (191) to the conduit (140) is performed in between successive operations of filling a first gas tank and filling a second gas tank to be connected to the nozzle, wherein the first gas tank is different from the second gas tank.
4. The system of example 3, wherein the step of controlling the switching circuit to fluidly connect the selected gas storage supply (191) to the conduit (140) is performed directly after completion of the operations of filling the first gas tank (252) and controlling to close the valve (153, 151).
5. The system of example 3 or 4, wherein the control unit (160) is configured to receive a pressure value of the inside of the second gas tank (252) and perform the selecting of the gas storage supply (191) based on the pressure inside the selected gas storage supply (191) and the pressure value of the inside of the second gas tank (252).
6. The system of any one of examples 2 to 5, wherein the inline cooling system is for refueling a fuel-cell based electric device, and the gas tank (252) is the gas tank (252) of the fuel-cell based electric device.
7. The system of example 1, further comprising
   a primary variable flow regulator (103) arranged along the conduit (140) to regulate a flow through the conduit;
   a secondary variable flow regulator (151) arranged along the conduit (140) to regulate the flow through the conduit; and
   wherein the at least one heat exchanger (106) is arranged along the conduit (140) in between the primary variable flow regulator (103) and the secondary variable flow regulator (151).
8. The system of example 7, wherein, in a fueling mode of operation, the primary variable flow regulator (103) is configured to, in a fueling mode of operation, restrict the flow of the fuel more than the secondary variable flow regulator (151) does.
9. The system of any one of examples 7 and 8, wherein the secondary variable flow regulator is configured to, in an initialization mode, gradually open until a pressure inside the conduit (140) has equalized with a pressure connected to the outlet (152).
10. The system of example 7, wherein the conduit (140) has a first diameter throughout the heat exchanger (106) and a second diameter outside the heat exchanger (106), wherein the first diameter is equal to the second diameter.
11. The system of example 10, wherein the conduit (140) has a fixed diameter throughout from the primary flow regulator (103) through the heat exchanger (106) to the secondary flow regulator (151).
12. The system of example 10, wherein the conduit (140) has the same fixed diameter in between any pair of fluid components arranged subsequently along the conduit (140) from the pressurized supply (190) to an outlet (152), wherein the pair of fluid components comprises two fluid components, wherein each fluid component comprises a valve, a flow regulator, or a measurement device.
13. The system of example 7, wherein a length of a portion (144) of the conduit (140) in between the heat exchanger (106) and the secondary flow regulator (151) is greater than 10 meters.
14. The system of example 7, further comprising a binary valve (153) to selectively close the conduit (145) in between the secondary variable flow regulator (151) and the outlet (152).
15. The system of example 7, further comprising
   a cooling apparatus (101) comprising a first housing enclosing the heat exchanger (106) and the primary flow regulator (103); and
   a dispenser (150) for dispensing the gaseous substance, wherein the dispenser (150) comprises a second housing different from the first housing, the second housing enclosing the secondary flow regulator (151),
   wherein the conduit (140) extends through the cooling apparatus (100) and through the dispenser (150), and
   wherein the cooling apparatus (101) and the dispenser (150) are disjunct devices.
16. The system of example 15, wherein the cooling apparatus (101) and the dispenser (150) are firmly connected to a ground, wherein a distance between the heat exchanger (106) and the dispenser (151) is greater than 10 meters.
17. The system of example 15 or 16, further comprising an active cooling element that extends along the part (144) of the conduit (140) in between the cooling apparatus (101) and the dispenser (150).
18. The system of example 7, further comprising a control unit (160) configured to control the primary variable flow regulator and the secondary variable flow regulator, based on a demand for the gaseous substance at the fueling dispenser.
19. The system of example 18, wherein the control unit (160) is configured to control the primary variable flow regulator to restrict the flow by a first fraction and control the secondary variable flow regulator to restrict the flow by a second fraction, based on a demand for the gaseous substance at the fueling dispenser, wherein the second fraction is less than or equal to 10%, preferably less than or equal to 1%, of the first fraction.
20. The inline cooling system of example 7, wherein the primary flow regulator (103) and the secondary flow regulator (151) are configured to cause a pressure drop of the gaseous substance at the primary flow regulator (103) to be greater than a pressure drop of the gaseous substance at the secondary flow regulator (151).
21. The inline cooling system of example 1, wherein the at least one heat exchanger has a shape of a torus.
22. A hydrogen refueling station for refueling fuel-cell based electric devices, in particular vehicles, comprising the inline cooling system of any preceding example.
23. A method of inline cooling for controlled delivery of a gaseous substance, in particular hydrogen, the method comprising
   transporting (601) the gaseous substance, in a pressurized form, from a gas supply unit (190), through a conduit (140) to an outlet (152);
   opening a valve (153, 151) arranged along the conduit (145) in between the heat exchanger (106) and the outlet (152);
   extracting (603) heat from the gaseous substance inside the conduit by at least one heat exchanger (106) arranged along the conduit (140) in between the primary variable flow regulator (103) and a secondary variable flow regulator (151) while the valve (153, 151) is open;
   closing the valve (153, 151);
   selectively fluidly connecting a selected gas storage supply among a plurality of gas storage supplies (191, 192, 193, 194) of the gas supply unit (190) to the conduit (140);
   selecting a gas storage supply (191) having a lower pressure than a pressure of the gaseous substance inside the conduit (140); and
   while the valve (153, 151) is closed, controlling a switching circuit to fluidly connect the selected gas storage supply (191) to the conduit (140).

1. An inline cooling system for controlled delivery of a gaseous substance, in particular hydrogen, comprising
a conduit for transporting the gaseous substance from a gas supply unit to an outlet, wherein the gas supply unit is configured to supply the gaseous substance in a pressurized form;
a primary variable flow regulator arranged along the conduit to regulate a flow through the conduit;
a secondary variable flow regulator arranged along the conduit to regulate the flow through the conduit;
at least one heat exchanger arranged along the conduit in between the primary variable flow regulator and the secondary variable flow regulator, wherein the heat exchanger is configured to extract heat from the gaseous substance inside the conduit; and
a control unit configured to control the primary variable flow regulator and the secondary variable flow regulator so that, in a fueling mode of operation, the primary variable flow regulator restricts the flow of the fuel more than the secondary variable flow regulator does.

2. (canceled)

3. The inline cooling system of claim 1, wherein the secondary variable flow regulator is configured to, in an initialization mode, gradually open until a pressure inside the conduit has equalized with a pressure connected to the outlet.

4. The inline cooling system of claim 1, wherein the conduit has a first diameter throughout the heat exchanger and a second diameter outside the heat exchanger, wherein the first diameter is equal to the second diameter.

5. The inline cooling system of claim 4, wherein the conduit has a fixed diameter throughout from the primary flow regulator through the heat exchanger to the secondary flow regulator.

6. The inline cooling system of claim 4, wherein the conduit has the same fixed diameter in between any pair of fluid components arranged subsequently along the conduit from the pressurized supply to an outlet, wherein the pair of fluid components comprises two fluid components, wherein each fluid component comprises a valve, a flow regulator, or a measurement device.

7. The inline cooling system of claim 1, wherein a length of a portion of the conduit in between the heat exchanger and the secondary flow regulator is greater than 10 meters.

8. The inline cooling system of claim 1, further comprising a binary valve to selectively close the conduit in between the secondary variable flow regulator and the outlet.

9. The inline cooling system of claim 1, further comprising
a cooling apparatus comprising a first housing enclosing the heat exchanger and the primary flow regulator; and
a dispenser for dispensing the gaseous substance, wherein the dispenser comprises a second housing different from the first housing, the second housing enclosing the secondary flow regulator,
wherein the conduit extends through the cooling apparatus and through the dispenser, and
wherein the cooling apparatus and the dispenser are disjunct devices.

10. The inline cooling system of claim 9, wherein the cooling apparatus and the dispenser are firmly connected to a ground, wherein a distance between the heat exchanger and the dispenser is greater than 10 meters.

11. The inline cooling system of claim 9, further comprising an active cooling element that extends along the part of the conduit in between the cooling apparatus and the dispenser.

12. The inline cooling system of claim 1, further comprising a control unit configured to control the primary variable flow regulator and the secondary variable flow regulator, based on a demand for the gaseous substance at the fueling dispenser.

13. The inline cooling system of claim 12, wherein the control unit is configured to control the primary variable flow regulator to restrict the flow by a first fraction and control the secondary variable flow regulator to restrict the flow by a second fraction, based on a demand for the gaseous substance at the fueling dispenser, wherein the second fraction is less than or equal to 10%, preferably less than or equal to 1%, of the first fraction.

14. The inline cooling system of claim 1, wherein the primary flow regulator and the secondary flow regulator are configured to cause a pressure drop of the gaseous substance at the primary flow regulator to be greater than a pressure drop of the gaseous substance at the secondary flow regulator.

15. The inline cooling system of claim 1, wherein the at least one heat exchanger has a shape of a torus.

16. A method of inline cooling for controlled delivery of a gaseous substance, in particular hydrogen, the method comprising
transporting the gaseous substance, in a pressurized form, from a gas supply unit, through a conduit to an outlet;
regulating a flow through the conduit by a primary variable flow regulator arranged along the conduit;
extracting heat from the gaseous substance inside the conduit by at least one heat exchanger arranged along the conduit in between the primary variable flow regulator and a secondary variable flow regulator; and
regulating the flow through the conduit further by the secondary variable flow regulator arranged along the conduit,
wherein, in a fueling mode of operation, the primary variable flow regulator restricts the flow of the fuel more than the secondary variable flow regulator does.

17. An inline cooling system for controlled delivery of a gaseous substance, in particular hydrogen, comprising
a conduit for transporting the gaseous substance from a gas supply unit to an outlet, wherein the gas supply unit is configured to supply the gaseous substance in a pressurized form;
at least one heat exchanger arranged along the conduit, wherein the heat exchanger is configured to extract heat from the gaseous substance inside the conduit,
a valve to open and close the conduit in between the heat exchanger and the outlet;
a switching circuit to selectively fluidly connect a selected gas storage supply among a plurality of gas storage supplies of the gas supply unit to the conduit; and
a control unit configured to control to close the valve, select a gas storage supply having a lower pressure than a pressure of the gaseous substance inside the conduit, and, while the valve is closed, control the switching circuit to fluidly connect the selected gas storage supply to the conduit.

18. The inline cooling system of claim 17, wherein the system is for filling a gas tank, wherein the outlet comprises a nozzle to which the gas tank can be fluidly connected, and the control unit is configured to control to perform the step of controlling to close the valve when filling the gas tank is completed.

19. The inline cooling system of claim 18, wherein the step of controlling the switching circuit to fluidly connect the selected gas storage supply to the conduit is performed in between successive operations of filling a first gas tank and filling a second gas tank to be connected to the nozzle, wherein the first gas tank is different from the second gas tank.

20. The inline cooling system of claim 19, wherein the step of controlling the switching circuit to fluidly connect the selected gas storage supply to the conduit is performed directly after completion of the operations of filling the first gas tank and controlling to close the valve.

21.-24. (canceled)
